(19) United States
(12) Patent Application Publication
(10) Pub. No.: US 2014/0324204 A1
(43) Pub. Date: Oct. 30, 2014

(54) METHODS AND APPARATI FOR IMPLEMENTING PROGRAMMABLE PIPELINE FOR THREE-DIMENSIONAL PRINTING INCLUDING MULTI-MATERIAL APPLICATIONS

(71) Applicant: Massachusetts Institute of Technology, Cambridge, MA (US)

(72) Inventors: Kiril Vidimce, Cambridge, MA (US); Wojciech Matusik, Lexington, MA (US)

(73) Assignee: MASSACHUSETTS INSTITUTE OF TECHNOLOGY, Cambridge, MA (US)

(21) Appl. No.: 14/256,894

(22) Filed: Apr. 18, 2014

Related U.S. Application Data
(60) Provisional application No. 61/813,229, filed on Apr. 18, 2013.

(51) Int. Cl. B29C 67/00; G06F 17/50

(52) U.S. Cl. CPC B29C 67/0088; G06F 17/50
USPC 700/98; 700/119

(57) ABSTRACT

A programmable pipeline for synthesis of multi-material 3D printed objects supports procedural evaluation of geometric detail and material composition, using program modules allowing models to be specified easily and efficiently. A streaming architecture enables only a small fraction of the final volume to be stored in memory. Output is fed to the printer with little startup delay. A variety of multi-material objects are described. Procedural control over surface and volume stages as well as dithering is provided, together or independent of each other.

### RELATED DOCUMENTS

The benefit of U.S. Provisional Application No. 61/813,229 filed Apr. 18, 2013, entitled Programmable Pipeline for Multi-Material Fabrication, is hereby claimed, and the entire disclosure of which is hereby incorporated fully herein, by reference.

### GOVERNMENT RIGHTS

Inventions disclosed herein were made with government support under Grant Nos. IIS-1116296 and CCF-1138967 awarded by the National Science Foundation, and under Contract No. N66001-12-1-4242, awarded by the Space and Naval Warfare Systems Center. The government has certain rights in these inventions.

### BACKGROUND

Inventions disclosed herein relate generally to the field of three-dimensional printing (referred to herein as 3D printing or 3DP), 3DP machines that print objects using a single material, and also and more particularly to 3DP machines that print objects using two or more different materials. The inventions relate more specifically to methods and apparati for efficiently controlling such multi-material 3DP printing operations, and further for providing a user with methods to programmatically control aspects of the specification for the surface and volume of such 3DP fabricated objects and thus the objects themselves.

State-of-the-art 3DP hardware is capable of mixing many materials at resolutions of 600 DPI or more, using, for example, photopolymer phase-change inkjet technology. Data representing each layer of the model is ultimately fed to the printer as a full-resolution bitmap where, for each pixel of a layer, a single material is specified and all layers together define on the order of 10′ voxels per cubic inch. As printed, a layer of material is often referred to as a 3DP slice. This poses an enormous computational challenge, as the resulting data is far too large to directly pre-compute and store. A single cubic foot at this resolution requires at least 10¹¹ voxels, and terabytes of storage. Even for small objects, the computation, memory, and storage demands are large.

At the same time, it is challenging for users to specify continuous multi-material output variations and/or mixtures at high resolution. Current printer software is designed to process inputs of polygon meshes with only a single material per object. Multiple materials are supported in a limited fashion, but only by statically assigning a single material to each mesh. Various companies have created proprietary formats to support their specific multiple-material equipment. Nevertheless, with current printing software, it is unclear, at least to the users, how the geometric data is translated to machine instructions, making the printing process difficult to control from outside, by the user, without the detailed proprietary information.

This makes it infeasible or impossible to provide a continuous gradation between multiple materials, an important capability of the underlying printer hardware that would be important to many advanced multi-material applications, if it were accessible.

Open-source single material efforts (e.g., RepRap, Fab@Home) largely target fused deposition modeling (FDM) printing processes, which are motion vector-based, low-resolution, and low-throughput architectures with limited support for multiple materials (multiple materials are handled as separate STL files, where STL is a widely used file format for representing 3D objects made of triangles. A recent Additive Manufacturing File Format (AMF) standard (ASTM Standard 2011) allows description of object geometry, its composition and color. Colors and materials can be specified with limited proceduralism, using simple expressions from voxel coordinates to material choices. However, the standard's per-voxel expressions have limited power. Further, no architecture has been proposed to efficiently implement the standard. The standard only supports a single expression. It does not describe a full programming language. There is no ability to construct complex logic and thus the expressiveness is quite limited. There is no ability to sample image textures or to make distance function calls. In addition, the file format does not describe an efficient implementation.

Similarly, known printer control software provides no support for providing material specifications independent of geometry definition. Thus there is no ability to specify material templates (e.g., repeating a pattern that defines a composite material, or defining a procedural gradation for functionally graded materials (FGMs)) that can be reused from a first geometry to other geometries. FGMs are heterogeneous materials whose material composition varies over the volume of a given object. For instance, a material that varies from one point to another regarding properties such as: density, flexibility, roughness, shininess, reflectivity, electrical conductivity, etc.

Relatedly, there is no ability to create multiple instances of the same shape, but with different material specifications. Likewise it is not now possible to make variations of the same shape—e.g. enlargements, reductions, simple distorting alterations, in the same or different materials.

In general, as used herein, 3D printing is a process of making a three-dimensional solid object of virtually any shape from a digital model. 3D printing is achieved using an additive process, where successive layers of material are laid down in different shapes. 3D printing differs from traditional machining techniques in that they mostly rely on the removal of material, such as by methods of cutting or drilling (subtractive processes). Thus, a commonly used synonym for 3D printing is additive manufacturing.

A large number of additive processes are now available. They differ in the way layers (generally referred to as slices) are deposited to create parts and in the materials that can be used. Some methods melt or soften material to produce the layers, e.g. selective laser melting (SLM) or direct metal laser sintering (DMLS), selective laser sintering (SLS), fused deposition modeling (FDM), while others cure liquid materials using different sophisticated technologies, e.g. stereolithography, (SLA) and photopolymer phase change technology. Each method has its own advantages and drawbacks, and some companies consequently offer a choice between powder and polymer for the material from which the object is built. The powders are deposited and then secured to each other, either by printed binder, laser activation, such as by sintering, or other joining action. The powder can be polymeric, ceramic, metallic, or even organic. 3DP machines are being developed that print biological materials, including living tissues. The main considerations in choosing a machine are generally speed, cost of the 3D printer, cost of the printed prototype, and cost and choice of materials and color capabilities.

Specifically, the following types of 3DP exist, and more will certainly be developed: Fused Deposition Modeling (FDM); Electron Beam Freeform Fabrication (EBF); Direct Metal Laser Sintering (DMLS); Electron-Beam Melting (EBM); Selective laser Melting (SLM); Selective Heat Sintering (SHS); Selective Laser Sintering (SLS); Plaster-based 3DP (PP); Laminated Object Manufacturing (LOM); Stereolithography (SLA); and Digital Light Processing (DLP). These vary in some aspects of their operation, and also have some aspects in common. It is challenging to design methods and apparati for generating buildable input to these machines, due to their differences, but, it would be advantageous to have such an input design capability that would take account of their similarities, particularly with respect to using more than one type of material for construction.

As used herein, a slice is a fundamental unit of material deposition specific to the type of 3DP machine in use. For instance, for the photopolymer phase change inkjet style printer, a slice is created at a single level, as a series of photopolymer droplets are dispensed and hardened. For a powder and binder type 3DP technology, a slice would be composed of a single layer of powder.

Thus, there is need for a method and apparatus and control software to drive multi-material 3D printers that would provide efficient use of memory storage and communication. It would also be desirable to provide such a method and control software that would synthesize the final voxels of material at full printer resolution, at the time the object is being printed. Also of interest would be to enable resolution independence for different hardware and output contexts, for instance to output a low-resolution rough prototype for informal purposes, or very rapid printing purposes. It would also be beneficial and desirable to enable specifying material definitions independently (decoupled) from specifying product geometry. It is also desirable to enable users to specify many different types of printed output generally, rather than requiring users to create a unique, stand-alone, one use only, static definition for each different geometry, or fabrication application. It would also be desirable to provide a method and apparatus and control software that is scalable, which works equally well for large and small, fabricated objects. In addition to such desirable methods and software, it would be desirable to provide hardware capable of carrying out these methods, either as specially programmed relatively general purpose data processing computers, or, as more specifically dedicated hardware elements, each dedicated in whole or in part to a particular stage of a pipeline method hereof.

These and other objects and goals of inventions hereof, as well as the inventions themselves are illustrated with reference to the Figures of the Drawing of which:

### BRIEF DESCRIPTION OF FIGURES OF THE DRAWING

FIG. 1 is a schematic representation in block diagram form of the overall user's view of the 3D Printing pipeline invention hereof, implemented either in hardware or software, or a combination thereof;

FIG. 2 is a schematic representation in flow chart form of a specific implementation of an invention hereof, such as can be conducted in a pipeline invention hereof as shown in FIG. 1, to fabricate an article by 3DP;

FIG. 3 is a digital image of a boundary representation of an input specification for a product to be fabricated by 3DP using inventions hereof, in this case, a bear;

FIG. 4 is a digital image of a tessellated boundary representation of the input specification of FIG. 3, with a surface discretized by tessellation to a first resolution;

FIG. 5 is a digital image of a tessellated boundary representation of the input specification of FIG. 3 that matches a printer resolution, with a surface further discretized by further tessellation to a second resolution, finer than the first resolution shown in FIG. 4, for which the underlying micropolygons approximately equal the size of a constituent voxel of a target printer to be used to fabricate the object;

FIG. 6 is a digital image of a modified boundary representation of a tessellated representation of the object to be made, with the surface further modified procedurally by a displacement, for instance to create an impression of a fuzzy furry surface, with a blow up of an ear portion thereof;

FIG. 7 is a digital image of a volume discretized modified representation of a volume discretized representation of the object to be made, with a blow up of an ear portion;

FIG. 8 is a digital image of a representation enriched with material composition, of FIG. 7, indicating also that there is associated with each discretized volume element, a list of pairs of a material and a quantity, such as by percentage, where the number of pairs is equal to the number of different materials (including as a material no material i.e., a void, that can be used in the object;

FIG. 9 is a digital image of a dithered representation of the volume discretized representation of FIG. 7, as output from a dithering stage, indicating that there is associated with each volume element at the resolution of the target printer, a single material, which material will actually be printed by the printer at the locations so indicated;

FIG. 10A is a digital images in a front view of an article fabricated using inventions hereof, showing a bear, having a central core of its body and its ears composed of a first material and external portions of its body composed of a different, translucent material, with transverse voids piercing the body, which composed together, simulatesfoam;

FIG. 10B is a digital image in a side view of the article shown in FIG. 10A, with the open ends of the transverse channels evident, as well as the darker central core;

FIG. 11 is a digital images in a side view of an article fabricated using inventions hereof, showing a rabbit, having a central core of its body (and its ears) composed of a first material and external portions of its body composed of a different, translucent material, with transverse voids piercing the body, made using the same fablet program module volume phase as was used for the bear shown in FIGS. 10A and 10B.

FIG. 12 is a schematic representation of a vertical cross-section of a product to be built, at the level of printable voxels, illustrating a user programmable fablet program module that queries distance of a particular voxel from a surface;

FIG. 13 is a schematic representation of a vertical cross-section of a product to be built, at the level of printable voxels, illustrating a method for calculating location of support structures needed due to overhangs, etc. showing voxels that are part of the object being printed, voxels that are support voxels;

FIG. 14 is a schematic representation of how a volume to be created is conceptually partitioned into slabs, along the direction (Z) of build-up, which slabs constitute the units upon which separate operations are performed, as shown schematically in FIG. 2, step 224 (for each slab);

FIG. 15A is a digital image of a front view of a lithopane structure fabricated using inventions hereof;

FIG. 15B is a digital image of the back, bas-relief surface of the lithopane structure shown in FIG. 15A;

FIG. 15C is a digital image of a front view of the lithopane structure shown in FIG. 15A, as illuminated from the rear, showing a shadow cast as a result of a displacement of the back surface, which, as material thickness varies, impedes light transmission in different locations differently;

FIG. 16 is a digital image of three articles fabricated using inventions hereof, all in the shape of a rhinoceros, with one item having alternating regions of its body composed of different materials, a second identically shaped rhinoceros, but with different surface and volume properties, generally having void channels throughout, established by different surface and volume fablet program modules from those used for the first article shown in FIG. 16 and a third rhinoceros, of the same geometry as the first two, but with further different surface and volume properties from the first two, established by different surface and volume fablet program modules from those used for the first two articles of FIG. 16;

FIG. 17 is a digital image of a butterfly embedded in a disk shaped block of amber, all fabricated by 3DP using inventions hereof;

FIG. 18 is a digital image of a table having a marbled variation in materials throughout its volume and upon its surface, fabricated by 3DP using inventions hereof;

FIG. 19 is a digital image of a micro lens array having transparent lenses in a frame of opaque material, fabricated by 3DP using inventions hereof;

FIG. 20 is a digital image of a bar composed of anisotropic materials, composed of relatively rigid straight rod-like structures within a surrounding volume of relatively flexible material printed using inventions hereof;

FIG. 21A is a digital image of a bar composed of anisotropic materials, composed of relatively rigid helical structures within a surrounding volume of relatively flexible material printed using inventions hereof; and

FIG. 21B is a schematic representation of the helical structures that are within the interior of the bar shown in FIG. 21A, with the surrounding volume of flexible material removed.

### SUMMARY

Inventions disclosed herein include methods and apparatus that constitute a programmable product synthesis pipeline that synthesizes final voxels of 3DP printing material at full printer resolution, on demand, while the object is printing, and the printer is demanding material specifications, that represent the geometry and material specification for a product to be made by 3DP methods. Inventions constitute a pipeline by virtue of the sequential order of operation of method steps by which the geometry and material specifications are determined and by which the products are fabricated, and also by the serial arrangement of hardware that conducts such method steps. The inventions are particularly useful for multi-material products and machines, but also have novel applications for single material products and machines. The material composition of individual voxels are determined, and then provided to the printing hardware, and thus printed, in a streaming fashion, with voxels of a first layer (slice) of a first slab being determined, provided to the printer, and printed, initially, before the material composition for individual voxels at other locations in the finished product are determined, provided, printed, etc. Voxel identity for the entire product is not determined all at once or in one stage, and is not stored all at once in any memory of any portion of the design or printing hardware. Thus, a memory and storage efficient method and system is provided. The product input specification can be resolution independent. Thus, the user may use the same product specification regardless of the resolution of the type of hardware being used. The resolution of the user's product specification may also be independent of other variations in hardware. The final output can be sampled at different resolutions, both in terms of the geometric resolution (e.g., whether the final surface is smooth or jagged) or the material composition resolution (the geometry can be sampled at printer resolution but the material composition could be evaluated at a lower resolution and then the material assignment gets smeared or re-mapped to the finer underlying printer voxel resolution).

Inventions disclosed herein enable a user to specify material definitions independently from geometry definitions (and vice versa). An invention disclosed herein is an implementation of a 3DP specific language and pipeline features that are also specific to 3D printing, which enable users to specify many types of procedurally printed output than can not be done with existing programming options, including writing individual programs for each different material or fabrication application.

In general, method inventions disclosed herein have been implemented in a system developed by the inventors hereof, and referred to informally herein as an OpenFab programming pipeline. An exemplary fabrication pipeline offers an expressive programming model for procedurally specifying the geometry and material of printable objects. Such an exemplary embodiment also includes a fabrication graph (referred to herein as a fab graph), which describes geometry and attributes. Small fabrication program elements, which can be somewhat modular, are referred to herein as fablet program modules. They allow users to programmatically describe the geometry, such as surface variations (e.g. surface roughness, spikes, depressions), color patterns, etc., and define material assignment in a compact, resolution and size-independent manner. The surface or volume features can be specified as functions of inputs, and thus, they are programmatic, or procedural, as that term is used herein. Given the programmatic freedom, material assignment can be done to describe complex fabrications such as functionally graded materials and composite materials. Fablet program modules also allow a user to specify a vast variety of features of either the surface or volume of an object by sampling or retrieving data from external resources such as, image textures or look up tables. Fablets can beneficially be written in a 3DP domain specific, C/C++-like, fully featured programming language that allows constructs such as variables, expressions, logical constructs, loops, user functions, a standard library of functions, etc.

Another aspect of an invention hereof is a scalable architecture for implementing a fabrication pipeline as discussed. By scalable, it is meant that the inventions hereof can be used for larger products as well as smaller ones without any compromise in their performance. There is no appreciable increase in time or cost to create larger products, as compared to smaller, other than the additional build time that it takes the 3DP machine to print out the larger part. As the build volume of the target object increases or as the complexity of its surface/volume fablet increases, the system can still handle it given certain storage requirements. It does not necessarily mean that the computational cost is same; however, any such higher computational costs are not a significant penalty due to the longer time the print takes to print due to the hardware. In other words, bigger/more complex prints do require more computation, but because computation is interleaved with printing, the additional computation does not affect printing time in addition to the longer time it takes because of the printer.

Since the total computational cost is large and it is not presently economically possible to fit the entire output volume into memory, a representative pipeline can progressively stream output to a printer with minimal up-front pre-computation and keeping only a relatively small slab of the volume memory at any one time. A compiler can analyze and transform the procedural computation described by small fablet program elements, as needed for efficient implementation in a fabrication pipeline.

Methods and apparatus and software pipelines that embody inventions disclosed herein have been used to specify and determine and fabricate a variety of multi-material 3D objects. Inventions disclosed herein can be used to describe meta-materials, functionally and compositionally graded-materials, and objects that contain materials with varied appearance and deformation properties. Also demonstrated are models characterizing three-dimensional items as well as the physical objects themselves, with extreme geometric detail and programmable surface properties, such as degree of displacement from a nominal starting surface, and volume properties, such as material combinations and void size and distribution. Several objects are described that were fabricated using a commercial multi-material 3D printer. The performance of implementation of inventions disclosed herein has been evaluated, and is reported herein.

An important embodiment of an invention hereof is a method for generating a volume discretized representation of at least one object, usable in connection with fabricating, by a 3DP method, at least one object that corresponds to the representation, at a specified printer_resolution of volume elements, to be printed by the 3DP method. The method comprises: tessellating a boundary representation of the at least one object to produce a tessellated boundary representation comprising a set of micropolygons, the micropolygons having a size that matches the specified printer resolution; evaluating, for the at least one object, a program module having a surface phase, which generates as an output a modified boundary representation, modified according to at least one procedural aspect of the surface phase; and volume discretizing the modified boundary representation at the specified print resolution, to generate a volume discretized modified representation comprising volume elements.

With an important variation of this aspect the at least one procedural aspect of the surface phase being selected from the group consisting of: applying a function to the tessellated boundary representation; sampling an image texture; a displacement; and procedurally determining surface attributes.

Yet another variation further comprises evaluating, for the at least one object, a program module having a volume phase, which generates as an output a volume discretized representation, which is enriched according to at least one procedural aspect of the volume phase.

It can be that the at least one procedural aspect of the volume phase comprise assigning at least one of a plurality of fabrication materials to each volume element to generate a volume discretized representation with material assignments. In addition or alternatively, the at least one procedural aspect of the volume phase can comprising assigning to each volume element, one of: a fabrication material; and, a void.

The step of assigning at least one of a plurality of fabrication materials to each volume element can be procedurally assigning at least two different materials in different degrees to generate a volume discretized representation graded material assignments.

With yet another modification, the step of assigning at least one of a plurality of fabrication materials to each volume element, can be assigning at least two fabrication materials to individual ones of at least some of the volume elements, thereby producing a blended material representation. This can be further modified with an additional step, based on the blended material representation, of generating a dithered representation of, in which each volume element is assigned at most a single material. From this, one can generate a dithered representation comprising a three-dimensional dithering. If the object is to be printed in a set of slices, the step of generating a dithered representation can comprise, within each single slice, applying a Floyd-Stenberg-type dithering technique.

In an important aspect, the step of generating a dithered representation may comprise, evaluating a program module having a dither phase, which takes as an input a user provided, sized, local neighborhood of volume elements of the blended material representation, and generates as an output a dithered representation of volume elements, composed of volume elements in a related, dithered neighborhood. Each volume element in the related, dithered neighborhood is assigned only a single fabrication material.

It can be very useful to also use the dithered representation to generate a machine-specific representation, which is specifically tailored to be used as an input to a specific type of 3DP machine.

Yet another embodiment of an invention hereof is a method for fabricating by a 3D printing method at least one object, described in a fabrication graph, the 3D printing method having a build direction, the at least one objects being arranged along the build direction in the fabrication graph. The method comprises: sorting the at least one objects in the build direction; partitioning the at least one object into a plurality of slab portions arranged in order along the build direction from a first slab to a last slab; and for each slab, beginning with the first and ending with the last, conducting the following steps: identifying all objects of which a portion of the object is within the slab; and for each object, conducting the following steps: tessellating the object; executing a surface fablet program module on the tessellated object; volume discretizing the tessellated object to produce a representation characterized by volume elements; and executing a volume fablet program module on the volume discretized object.

An important variant of this aspect is the step of executing a volume fablet program module on the volume discretized object which generates as an output a blended material representation of the object.

It is very useful to also dither the blended material representation thereby generating a multi-material dithered representation of the object in which each volume element is assigned only a single material.

Still another aspect of an invention hereof is An apparatus for generating a volume discretized representation of at least one object, usable in connection with fabricating, by a 3DP method, at least one object that corresponds to the representation, at a specified printer resolution of volume elements, to be printed by the 3DP method. The apparatus comprises: a tesselator configured to tessellate a boundary representation of the at least one object to produce a tessellated boundary representation comprising a set of micropolygons, the micropolygons having a size that matches the specified printer resolution; a surface stage processor, configured to evaluate, a program module having a surface phase, which generates as an output a modified boundary representation, modified according to at least one procedural aspect of the surface phase; and a volume discretizer, configured to discretize the modified boundary representation at the specified print resolution, to generate a volume discretized modified representation of volume elements.

A related embodiment further comprises a processor configured to evaluate, for the at least one object, a program module having a volume phase, which generates as an output an enriched discretized representation of volume elements, which is enriched according to at least one procedural aspect of the volume phase.

For a related embodiment, the at least one procedural aspect of the volume phase comprises assigning at least one of a plurality of fabrication materials to each volume element to generate a discretized representation of volume elements, enriched with material composition.

With another related embodiment, the at least one procedural aspect of the volume phase comprises assigning at least two of a plurality of fabrication materials to each volume element to generate a discretized representation of volume elements, enriched with blended material composition.

A very useful related embodiment further comprises, a ditherer, which, based on the blended material composition, generates a dithered representation of volume elements, in which dithered representation, each volume element is assigned at most a single material. The ditherer may beneficially be a procedural ditherer, including a three-dimensional ditherer.

When the object to be printed by the 3DP method in a set of slices, the ditherer can comprise a Floyd-Steinberg-like ditherer, which takes into account material information from a single 3DP slice and also slices adjacent to the single slice. Further, there can be a 3D printer specific output processor, which generates, based on the dithered representation of volume elements, a representation of the volume elements in a form suitable for the 3DP machine to directly output material as a slice of volume elements. The 3DP printer specific output processor may beneficially be a raster slice generator.

Yet another important class of related embodiments are computer program products for generating a volume discretized representation of at least one object, usable in connection with fabricating, by a 3DP method, at least one object that corresponds to the representation, at a specified printer resolution of volume elements, to be printed by the 3DP method, the computer program product comprising computer executable code embodied in a non-transitory computer-readable medium that, when executing on one or more computing devices, performs any of the steps of method aspects of inventions mentioned above.

Finally, yet another important class of related embodiments are computer systems configured and programmed to perform any of the method aspects of inventions hereof, as set forth above.

### DETAILED DESCRIPTION

Inventions disclosed herein enable combining many materials with different optical and mechanical characteristics at inkjet printer resolution and thus, fabrication of extremely complex objects with a multitude of unique and spatially varying properties. Such objects can be fabricated directly from a digital description.

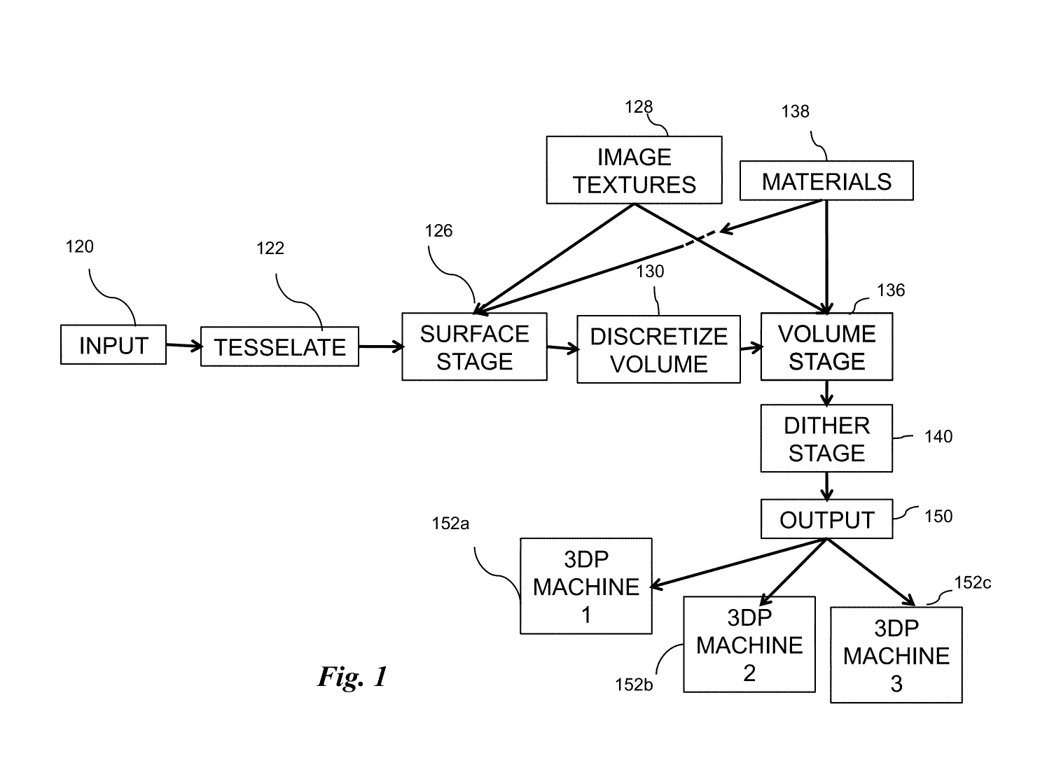

An invention hereof is a pipeline-type architecture for a method of an invention, shown schematically in FIG. 1, at 110, as contemplated by the user. Some of the operations can be individually programmable by the user. Some steps or operations can be less customizable by a user. Some of the steps are in fact a combination of many steps, and groups of operations. The term pipeline is used herein, generally as that term is used in the computer programming industry, to mean a series of processing stages that follow one after other, although that term should not be considered to be unduly limiting.

In general, a pipeline method hereof is a series of steps which, starting with a basic input(s) take as an input, an output from a prior step or stage of fabrication apparatus, and produce an output that is the input to a subsequent step further downstream, or stage of fabrication apparatus. The initial and final steps, of course, rather than the foregoing, take user inputs, and provide an output to the user, such as final instructions to a 3DP machine, or, the actual physical three dimensional product output from such a machine.

It will be understood that in general, 3DP machines are provided with inputs and controlled by data processing equipment in the form of either programmed general purpose computers or more dedicated, programmed special purpose data processing computers both operating under the influence or instructions from computer executable code stored in a non-transitory computer readable medium (such as a compact disc, hard drive, volatile or nonvolatile memory, etc.) that, when executing on one or more computing devices such as any suitable processors or processing circuitry, performs some or all of the steps described above.

In such embodiments, it will be understood that the object to be fabricated may be specified in a computer model such as a computer-automated design model, a stereolithography file, or any other useful computerized representation, which may in turn be converted into a set of 3DP machine instructions that can be applied directly by a controller or the like to fabricate a physical realization of the object. Thus fabrication as described herein may also include processing a computerized representation of an object to obtain 3DP machine instructions.

A role of the pipeline is to process a combination of inputs, such as geometry inputs coupled with fablet program modules, (described in detail, below). (Each geometric input has one assigned fablet program module). The fablet program module can then refer to image textures and materials (i.e., external resources), to generate instructions for 3DP device-specific fabrication output. As used herein, fablet program module means a fabrication related, reuseable set of computer data processing program instructions prepared by a user.

The pipeline concept is helpful to envision that aspects of one portion of the end product are determined after aspects of another portion of the end product were determined and fabricated in advance, and while aspects of another portion of the object, which were determined earlier in the process, are being fabricated, and further, where aspects of yet another portion of the end product will be determined at a later time, after which time, they will be fabricated. As such, the process is a streaming process, where instructions for part of the process are determined and generated while earlier parts of the process are underway.

This pipeline structure for determining the 3DP machine inputs is particularly useful for 3DP, because the printing-out process of the physical part can be somewhat or even very time consuming. Thus, while initial portions of the final product are being printed out, there is ample time for the computing hardware to determine the 3DP instructions for printing out other portions of the part to be printed out subsequently.

Not only are method steps of inventions hereof conducted in series as a pipeline, as discussed above, but also, physical, hardware implementations of inventions hereof can be composed of hardware elements arranged serially in a pipeline, which operate on inputs, which inputs are outputs of upstream elements, and which elements generate outputs that are used as inputs to downstream elements.

The user controls the process by providing inputs defining aspects of an end product, such as geometry and volumetric composition, setting pipeline attributes, such as which of several methods to use to determine surface distances or the resolution at which to evaluate different components, such as material composition) and defining fablet program modules. User-programmable fablet program modules procedurally transform and compute surface attributes at each vertex of an object mesh, and compute the material mixture output at each point within the mesh volume. The overall architecture can evaluate an object specification on demand, i.e., while the object is being printed (fabricated).

To achieve scalability necessary for printing large build volumes at native resolution, (i.e., the resolution of the actual 3DP machine that will print out the object), the methods and hardware arranged in a pipeline architecture of inventions hereof typically use computation that is performed very close in time before it is needed by the printer, and stored, if at all, only for brief periods of time. This is in contrast to a system that might pre-compute all or most of the necessary data and then store it, and then read/send it to the printer when it is needed. Thus wherever possible, the system can streams over the output volume in an order required by the printer. It also requires as little up-front pre-computation as possible, to minimize printer startup delay. The computation can be performed locally to the printing machine, such as on a local computer or a processor embedded in the printing machine, or, at some distance or in the world wide web or other data and processing cloud, and transmitted to the printing machine over data lines, or wireless transmission.

Although just in time computation is very practical, some aspects of inventions hereof need not be used in conjunction with a streaming or just in time system. For instance, the programmatic aspects, particularly the ability to programmatically define surface and volume aspects, and also other features, such as object priority and dithering are useful independent of any streaming and/or just in time computation aspects disclosed herein.

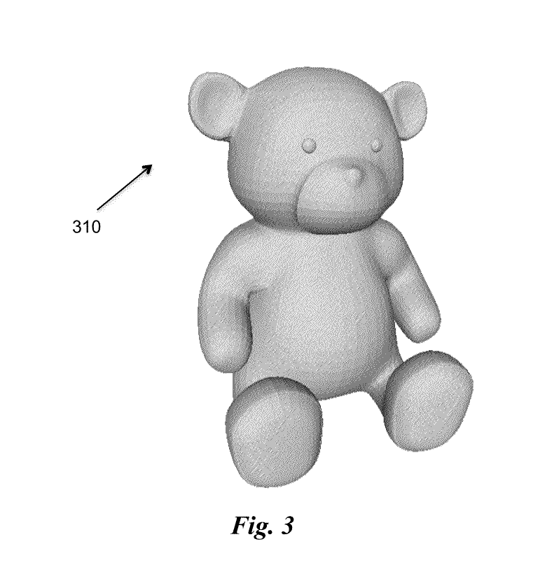

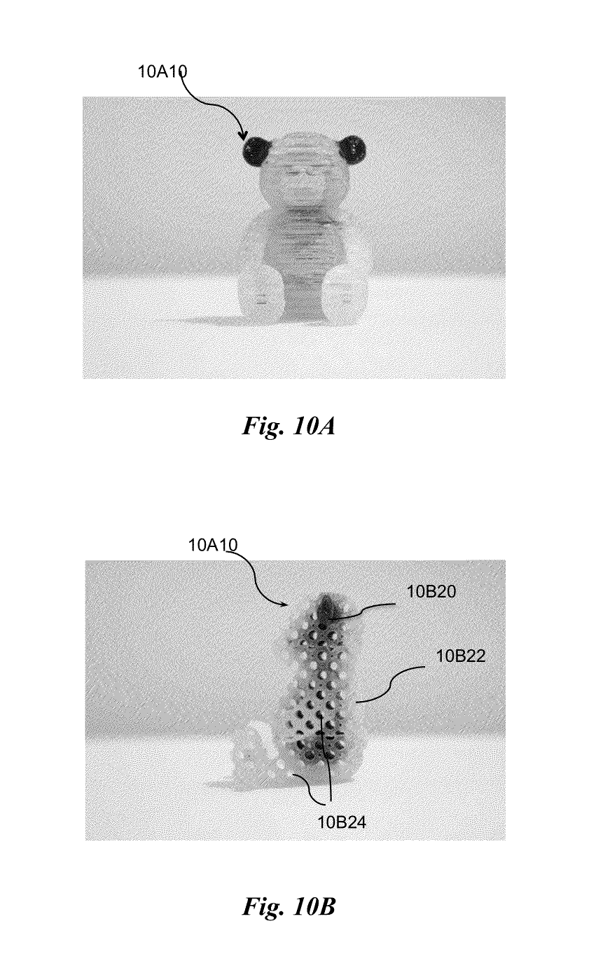

Stages of a representative inventive pipeline method and apparatus are shown schematically in flow-chart form in FIG. 1. Some of the stages can be fixed and others can be programmable by the user. For a product to be fabricated, such as the bear #10A10 shown in FIG. 10A, an input of the input stage 120 of the pipeline 110 is a data description of the bear. The input description consists of a set of parameters, including but not limited to: geometric description (such as object boundary representations) and associated attributes such as transforms, image textures, materials and fablet program modules. For instance, in an example discussed herein, the bear 310, shown in a digital image of FIG. 3, represents a digital description or specification of an object boundary representation of the fabricated bear #10A10. This is discussed in more detail below.

The user input specification can be embodied in a fabrication graph (referred to herein briefly as a fab graph) of nodes and edges, which identifies and relates components of the items to be fabricated. In general, types of nodes can include but are not limited to: materials, image textures, shapes, objects, transforms and fablet program modules. A single object consists of a node with associated references (edges) to other nodes. Thus, a fully defined object can be a coupling of a shape, a fablet program module (with volume and surface phases), materials used by the fablet program module, and optionally can include also image textures and transforms (if the fablet program module uses image textures and if the shape needs to be transformed).

As used herein, an image texture may be an attribute of a surface or a volume. An image texture is strictly an image (such as in the data formats of JPG, PNG, GIF, etc.). The user can put arbitrary data in the image texture. The data can be pictorial, (i.e., a photo or drawing of something) or simply a one, two, or three-dimensional table whose values represent matters decided upon by the user. For instance, these matters can be: colors, displacements, materials, conventional topographical surface roughness, temperature, pressure, results of an FEM simulation, final material composition over a volume or any property that the user wishes to specify at different locations on the surface and/or within the volume of the object to be made. The image texture can be represented by data or information in one, two or three dimensions. These values can be looked up in the fablet program module and by means of the fablet program module, the user directs what to do with the values. Image textures are discussed in more detail below.

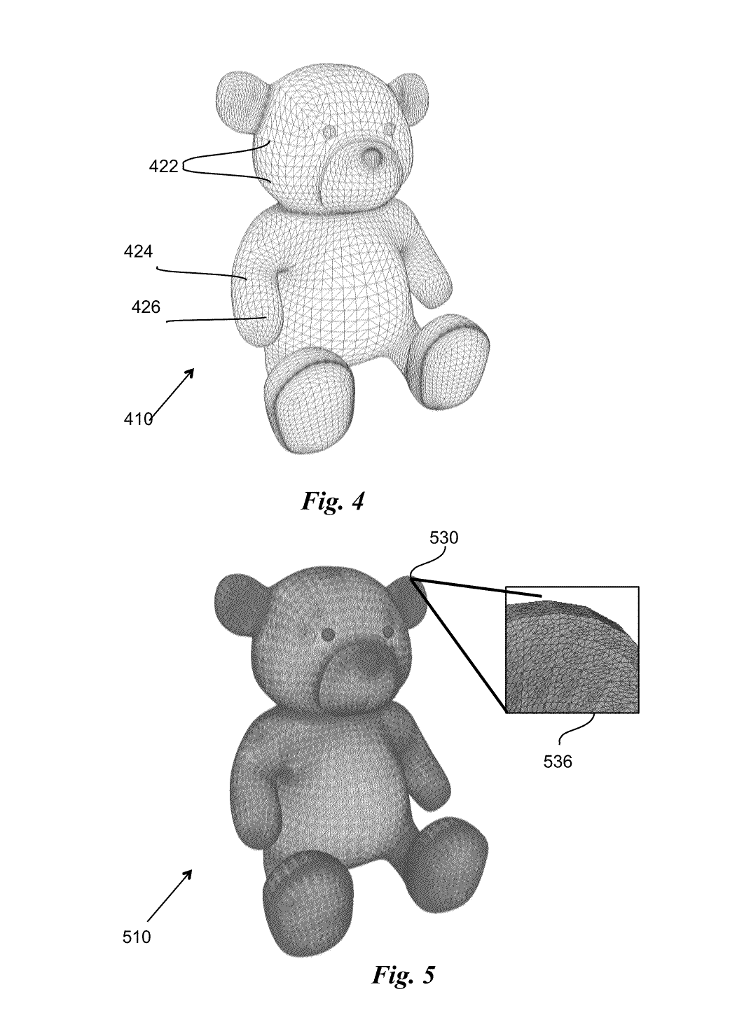

Another concept that is important at this point is that of texture coordinates. Texture coordinates are used to help to map, or correlate the values that make up the image textures to locations of the geometric representation of the object to be made. Texture coordinates are assigned to vertices of the boundary representation 410 (FIG. 4). These coordinates then specify where, from within the image texture, the system finds the value to associate with any given vertex of the boundary representation. If the input geometry is further tessellated, the texture coordinates can be interpolated also. In fact, the texture coordinates can also be interpolated volumetrically.

An important characteristic of using image textures (also called texture mapping) to the representation of the object to be made, is that the input data (from the image texture) can be sampled in a variety of ways. It can be point sampled or filtered. Filtering is important because the surface area or volume being fabricated with the characteristic from the image texture (in fabrication space) rarely maps to a single pixel (also called a texel) in texture image space. Most often the surface area (or, volume) being mapped to the image texture maps to more than one texel and thus filtering can be performed. In the simplest case, a box filter can be applied that averages the contributions of all of the relevant texels within the local neighborhood. The term image texture is used herein to refer to these aspects of mapping from an image texture to a representation of an object to avoid confusion between these concepts of image textures used for texture mapping and texture as used in common parlance to mean surface variations, such as roughness, ridges, grooves, bumps, etc.

A fablet program module (discussed in more detail below) can procedurally define the material content of an object to be fabricated.

Fablet program modules may be beneficially written in a language that is tailored to their composition, designed for 3DP, taking into account the specific volumetric and material composition considerations of three dimensions. An advantage of inventions disclosed herein is that the process of material assignment is organized so that users can specify material composition in a general way without taking into consideration the actual underlying process (e.g., SLA vs. powder-). The fablet program modules can provide a flexible toolset that supports many common material specification tasks. The inventors hereof have developed such a language, which is referred to herein as OpenFL, however, it is just one instance of a suitable language. Thus, such suitable languages are referred to herein at times as OpenFL-type languages.

A suitable OpenFL-type language for composition of fablet program modules can be a C++-like programming language. Such a language can beneficially describe both surface and volume functionality together, as methods, on a single object fablet program module. Unifying the components under the same fablet module has advantages. One such advantage is that any parameters or data that is used by both can be defined once rather than multiple times. However, it would also be possible to have separate surface and volume program modules that are coupled together in some fashion. Uniform parameters, including image textures and material IDs, can also be declared in the object. Such an appropriate OpenFL type program can usefully include a standard library with common math, image texturing, and other routines. Such a standard library also can include functions to query the distance to the nearest point on the surface, as well as any interpolated mesh attributes at that point.

Such a suitable OpenFL-type program can be compiled by a fablet compiler that is fully implement or built using existing compiler frameworks such as LLVM (Low-Level Virtual Machine). LLVM implements common compiler optimizations and performs the final translation to machine instructions. The so called front end of the compiler can be written that parses the input program and translates it into an LLVM intermediate representation. The LLVM library can then be used to optimize the program and generate machine code that can then be executed as part of the pipeline invention hereof. Thus, fablet program modules can be compiled to final machine code a priori or can be staged so that they are compiled to an intermediate representation offline (before fabrication starts) and then bound to certain parameters at runtime performing just-in-time compilation before fabricating. The latter strategy (staging+late binding/JIT) allows for certain compiler optimizations. For instance, consider the case where the fablet program module performs something conditionally based on an input parameter value (e.g., if x is 10, then do something). The user specifies the value of parameter x and this value is known when fabrication begins, before compilation. When compilation is staged, the value of x can be bound and then a second, just-in-time compilation step can be performed, which allows determining if the conditional will be evaluated such that x is 10 or not. That entire branch can then be removed, and it is only necessary to include the code under the -is 10- or -is not 10- side of the conditional.

Using a programming language specific to the domain of 3D printing provides opportunities to both analyze and transform the computation defining fablet program modules. For example, a suitable compiler can generate interval versions of each fablet program module to facilitate automatic inference of displacement bounds or other run-time optimization. It can also allow fast data parallel code generation.

In an early (upstream) stage of a representative pipeline invention hereof, the surface of an input object description 310 (FIG. 3) can be discretized, such as via a tessellation stage 122. FIG. 4 shows a digital image representation of a discretized instance 410 of the object #10A10 to be made (but without any representation of the voids/channels or color variations). This is a tessellated boundary representation. Tessellation generates micropolygon primitives 422, such as quadrilaterals, or, in some cases, triangles, which constitute the common surface representation throughout the pipeline. The micropolygons 422 are defined by vertices 424, connected by segments 426.

Next, in a surface stage 126, the surface phase of the pertinent fablet program module is evaluated for all micropolygons. The surface stage 126 takes advantage of a surface phase of fablet user program modules, specific to the surface, as discussed below. The surface stage A#26 also has access to image textures 128. Image textures are related to the vertices of the surface using texture coordinates, which can be either determined programmatically within the fablet program module or provided by the user as 1D, 2D or 3D coordinates associated with vertices on the surface. Texture coordinates can automatically be interpolated during the tessellation stage 122 so that newly introduced vertices on the surface get an interpolated texture coordinate. This texture coordinate can be used to look up values from image textures 128.

The user can specify arbitrary surface attributes for each vertex. These attributes can come in sets; i.e., set A of surface attributes specifies a first attribute for each vertex on the surface. Then another set B specifies a different, independent attribute for each vertex of the surface, and so on for as many sets as the user establishes. One type of surface attribute can be texture coordinates as mentioned above. Thus, a surface attribute is a generalization or super set of texture coordinates. The user can then use the surface attribute at a given vertex in arbitrary ways. Texture coordinates are usually used to lookup values from image textures 128.

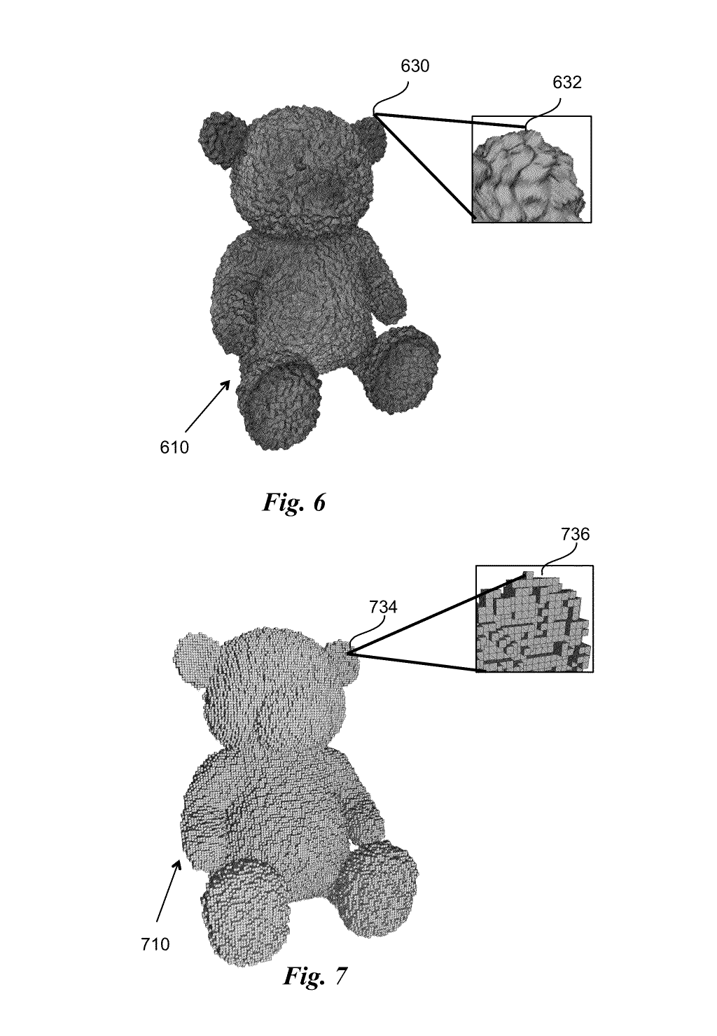

At the surface stage 126, the surface geometry of the model can be optionally, programmatically displaced to form a modified boundary representation, such as shown at 610 of FIG. 6, with an enlarged view of a digital image of the surface of the ear 630 shown at 632, for instance to indicate fuzzy fur. This is discussed below.

The user can access the image textures 128 in both the surface and the volume phases of the fablet program module. When accessing them in the surface phase, the user would usually (but not always) use texture coordinates specified on the surface. Since the surface phase of the fablet program module is evaluated on samples of the surface, the texture coordinate used for a particular lookup is the one that is interpolated from the specified texture coordinates. In the volume phase of the fablet program module, the procedure can be a bit more complicated. Since the volume phase runs on samples (voxels) inside the volume, there is not a one-to-one mapping of voxels and texture coordinates. Instead, a typical procedure is for the user to query the closest point on the surface to the voxel and get the texture coordinate at that location. Then a(n) image texture lookup is performed. The user can use other strategies to perform lookups from image textures, though i.e., by generating texture coordinates programmatically. Texture coordinates can also be interpolated within the volume.

The surface phase of the fablet program module, evaluated in the surface stage 126 also has access to materials 138, which can be useful in situations where the surface phase of the fablet program module creates material definitions over the surface that can then be queried in the volume phase of the fablet program module. For instance, consider mapping an image texture over the surface of an object. It would be possible to either: perform the image texture lookup in the volume phase of the fablet program module for every voxel within a given distance of the surface; or one could do the mapping once at the surface and then simply retrieve it during the volume phase of the fablet program module. The latter is a better approach.

The volume discretization stage 130 discretizes the volume enclosed within objects, such as via voxelization. Other forms of volume discretization include, but are not limited to tetrahedralization. Any suitable form of volume discretization may be used. FIG. 7 shows a digital image of a volume discretized representation 710 of the surface displaced bear 610, with the entire volume, illustrated by the ear 734, divided up as shown in the enlargement GA at 736, into tiny volumes, known in some cases, as voxels. Thus, FIG. 7 shows at 710 a volume discretized modified representation of the bear. In the volume stage 136, the volume phase of the relevant fablet program module can be evaluated over each voxel. The volume stage 136 can also be programmable by the user, and allows the user to access the same image textures 128 available in the surface stage 126 and also material definitions 138.

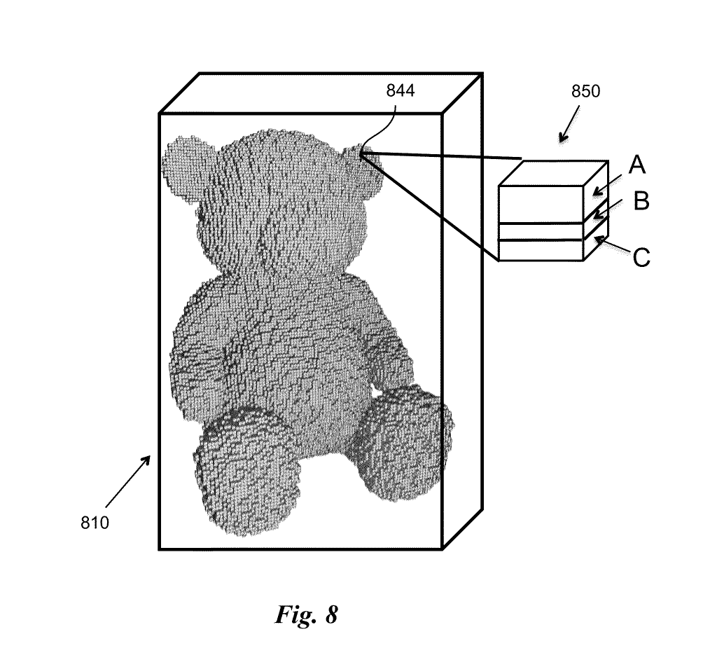

The output of the volume stage 136 can be shown conceptually by the digital image of an enriched with material assignments volume discretized representation bear 810 of FIG. 8, which is a continuously defined mixture of material quantities at a location 844, such as an ear tip. At this location, the user can ascribe a mixture of materials A, B and C, as shown enlarged at 850. For instance, the output of the volume stage 136 would be that a voxel at the location 844 of the ear tip would be composed of a mixed, or blended combination of 50% material A, 25% material B and 25% material C. By combination, it is meant as if in the same volumetric space, all three of these components A, B and C were present in a mixture of those proportions. But, 3D printing machines cannot print at a resolution finer than a single voxel. Thus, volumetric quantization and discretization of material quantities in neighborhoods around such a voxel must be conducted. Such quantization and discretization can be performed in a dither stage 140, discussed in more detail below. (The larger image 810 is not shown to be any different in composition than that of 710 shown in FIG. 7, because the image would be impossibly cluttered in a black and white representation. But it is to be understood that each volume element in the entire ENRICHED discretized representation bear 810 might, potentially, be divided up into fractional portions to which different materials would be assigned, as shown at 850 for a single volume element.)

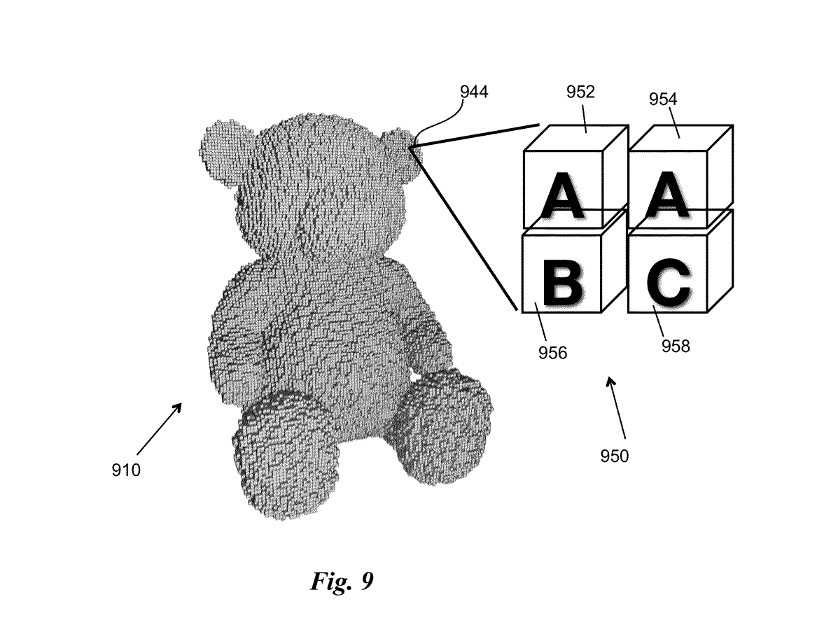

The dithering stage 140, generates a dithered representation 910 that represents each volume element assigned to a single material, with the assignment of materials for each voxel in a neighborhood of volume having been determined based on the mix of materials in volume elements of the same neighborhood of the representation of the object 810 generated by the volume stage 136. This is depicted in FIG. 9, which is a digital image of a dithered representation of the bear data under construction, showing from the region of the ear 944, four individual voxels, 952, 954, 956 and 958, of which two (50%) 952, 954 are composed of material A, and one each (25%) 956 and 958 (25%) are composed of material B and C, respectively. (As with the item 810 of the pre-dithered FIG. 8, the bear dithered representation 910 is shown the same as the previous representations, but for the enlarged portion 910, because to show the variation in material from volume element to volume element would be impossibly cluttered at the level of detail and scale shown for the bear 910. However, it will be understood that every volume element 952, 954, etc, in the dithered representation has an individual and potentially different material assigned to it. A difference, however, between the dithered representation 910 of FIG. 9, and the pre-dithered (enhanced discretized volume) representation of 810 of FIG. 8, is that individual volume elements 850 of the pre-dithered representation 810 may have a blend or mix of multiple materials assigned to each volume element, in fractions that add up to 100%, while each individual volume elements 952, 954, etc., of the dithered representation 910 has only a single material assigned to each volume element.

The dithered result from the dither stage 140 is provided to an output stage 150, which can produce an output that is specific to the actual 3DP machine 152a, 152b, 152c, etc., being used to print the object. This can be done via different back-ends of the output stage 150, discussed in more detail below.

It should be noted that the resolution of the data as shown for the pre-dithered bear 810 in FIG. 8 and the dithered bear 910 shown in FIG. 9 is the same—the sizes of the volume elements are equivalent, and located in the same places. However, for the pre-dithered bear 810 shown in FIG. 8, the materials are assigned such that each voxel can be composed of more than one material—which could not be physically created by any machine now in use. For the dithered bear 910 shown in FIG. 9, the materials are assigned one material per volume element. The arrangement of which materials are assigned to which volume elements in FIG. 9 is a sort of function, as controlled by the dithering routine, of the locations and amounts of materials assigned to the volume elements shown at FIG. 8, as output from the volume stage 136. The region of the ear 844 shown in FIG. 8 is a single volume element 850, while the region 944 shown in FIG. 9 are four volume elements 952, 954, 956 and 958, which are in a neighborhood associated with volume element 850, determined by the dithering scheme.

A suitable pipeline of an invention hereof can be implemented in many ways. It can be implemented as steps performed by a suitably programmed general purpose digital data processing computer under the control of computer executable code, which steps take inputs and generate outputs as described above. Or, it can be implemented as a number of separate, specialized and more dedicated hardware components that are somewhat optimized to perform some or all of the steps of the pipeline. Thus, as shown in FIG. 1, a representative pipeline would constitute an input stage 120, a tessellation stage 122, a surface stage 126, a volume discretization stage 130, a volume stage 136, a dithering stage 140 and an output stage 150, whose output is provided to a 3DP printer. Both the surface stage 126 and the volume stage 136 make use of user programmable fablet program modules to govern the operation of the steps or the hardware, as the case may be.

Generally, for each object, there is one surface phase of a fablet program module, and one volume phase of a fablet program module. The associated fablet surface and volume phase for a single object may be within the same fablet program module, or may be separate, but associated modules. Similarly, if implemented in dedicated hardware, the surface fablet module may physically reside in, or be coupled to a dedicated surface stage hardware component, and the volume fablet program module may physically reside in, or be coupled to a dedicated volume stage hardware component. The surface and volume fablet modules may be within or coupled with the same hardware component, or separate ones. Inputs to the surface stage 126 may also be available to the volume stage 138, either as software components or signal elements.

Thus, as used herein, the terms input stage 120, tessellation stage 122, surface stage 126, volume discretization stage 130, volume stage 136, dithering stage 140 and output stage 150, may be considered to refer to herein a respective hardware element for each (e.g., a tesselator, a ditherer, etc.), or a step or series of programming steps (e.g., a tessellation step, a dithering step, etc.), in computer executable code, stored on a non-transitory computer readable medium, or, streaming over a data link, which control a general or specialized purpose digital data processing computer. In either case, the elements of the system, either hardware or method, can be arranged serially in a pipeline. Further, if hardware, one or more of the stages may be physically composed within the same element of hardware. For instance, there may be a unit that combines the functions of the surface stage and the volume stage, or the volume stage and the dithering stage.

Some aspects of a representative input stage, mid-pipeline stages, and output stage, are described next in more detail, highlighting important elements of the overall architecture.

### Input Specification

The input specifications that are provided to the input stage 120 can be specified via either a C++ Application Programming Interface (API) or an accompanying file format. A suitable API supports the definition of geometry in the form of a closed, boundary representation geometric shape that can be defined either with a mesh of primitives (triangles, quadrilaterals or general polygons) or a higher-order surfaces such as NURBS, B-Splines or subdivision surfaces. Alternatively, it can be specified directly with a volumetric representation such as voxels or an octree. For instance, in an example discussed herein, the bear representation 310, shown by digital image at FIG. 3, constitutes the input geometric shape. The shape is water-tight, as that term is used in the 3DP industry. It defines the boundary of the object. Everything inside that boundary is part of the object and part of the volume being fabricated. An object can be the entire bear 410. Or, if the designer desires, the bear could be composed of several shapes. For instance, the head could be one shape and the body and arms and legs could be a second, separate shape. Each shape is associated, with one and only one fablet program module and together they form a fabricable, or printable object.

Pipeline inventions hereof should beneficially be able to handle constraints imposed by the mechanics of the underlying printing process. For instance, many 3D printers print 2D layers (generally referred to as slices) sequentially along one of the world axes. This constrains the order in which the input specification needs to be interpreted, and the order in which the output needs to be written. In other words, it is efficient for the pipeline method invention to work first with the portions of the input specification that relate to the parts of the object that will be printed first, and then to proceed to other parts thereafter. Were the entire output to be generated offline before sending any of it to the printer, and then provided to a fabricator as an integral whole, it might be useful to manipulate the input specifications in a different order. But that is not, in general, how inventions disclosed herein are intended to be used.

Fablet program modules can be written in a suitable dedicated programming language, such as OpenFL described above, or equivalent, or in any suitably capable language. They can provide surface and material definition. Both the shape representation and the fablet program modules can be reused for different objects to be printed. Each printable object couples a geometric shape with a fablet program module and accompanying data bindings. Complex prints, such as a mechanical assembly, may contain numerous objects, some of which are composed of instances of the same geometric shape (e.g., a bolt or a gear) coupled with a transform, fablet and optional ancillary data such as surface attributes. A transform positions, rotates and scales a shape.

Inventions hereof allow for the specification of object priorities defined as an integer value, for instance, 1 and 2. If two or more objects end up populating the same voxel, either by design or as a result of a displacement, it is an invention hereof to give priority to the object with a higher priority value, with respect to which fablet program module is evaluated in locations of overlap. The fablet program module that is bound to the object with the higher priority governs the voxels of overlap. This effectively allows constructive solid geometry (CSG) operations such as union and difference, but not intersection.

Consider a solid object comprising a butterfly 1710 within a block of amber 1720. This item is fabricated from three different materials. There are three principal elements that are being printed in this case: the amber block 1720, which encompasses everything, the butterfly 1710, which is embedded in the block and finally the (simulated) air bubbles 1724, which are also embedded in the amber block 1720. These three are created as follows: the amber block 1720 and the butterfly 1710 are described using geometric shapes. They are part of the input. The butterfly object has higher priority than the amber block object, so, everywhere the butterfly object appears, its material composition has priority, and is chosen, and thus, printed. Additionally, the air bubbles are described procedurally as part of the volume phase of the fablet program module coupled with the amber block. So, in some places, fablet program module for the amber block emits pure transparent material; in others it emits void, which, in this case, the printer fills with support material. The support material, although somewhat transparent is different enough than the primary transparent material used to fill the amber block and thus creates the appearance of air bubbles. This effect of printing support material where voids are returned is effective in some cases to effectively achieve a material composition of one more item than the printer nominally provides. If a different colored support material were chosen, the appearance would be different. If the void locations were on the object periphery, rather than its interior, then the support material would have been removed and actual voids would occur.

Given the ability to use the surface phase of the fablet program module to fine-tune the geometric details at the surface level, such as by displacement, the interface between two objects that are in contact can be very hard to define from a strictly geometric point of view.

As an additional example or priority use, consider a desired end product that constitutes a bear of a first material inside a translucent block, for instance a cube, of a different, transparent material. The bear also has a procedurally generated displacement of its surface to give a sense of fuzziness of its fur, such as shown in the digital image of FIG. 6. The displacement may result, after volume discretization, in the bear partially occupying some volume elements, with the surrounding clear block partially occupying the same volume elements. This is illustrated with the blow-up 7B of FIG. 7, which shows the same portion of the volume discretized modified boundary representation bear 710 as is shown in blow-up 7A at 736, but shown in only two dimensions to simplify explanation. The enclosed, lower region 740 represents the bear 710. The open, upper region 750 represents the surrounding clear block. For the volume elements 745 in the (vertically) middle row, the displacement process results in both bear and surrounding block being represented.

The bear object can be given a higher priority than the surrounding transparent block. At locations where a portion of each the bear object and the surrounding block object populates the same volume element, for instance due to the displacement of the bear surface to become fuzzy fur, the system chooses the object with the higher priority, in this instance, the bear, and takes steps to assign its properties of material at that volume element.

### Tessellation

A tessellation stage 122 takes the geometry input, such as the boundary representation of the bear 310 surface shown in FIG. 3, and reduces it to a collection of micropolygons, such as shown at the tessellated boundary representation 410 in FIG. 4. This then becomes a common internal surface representation throughout the pipeline.

The resolution of a printed 3DP object can be expressed in dots of printed material per lineal distance. The resolution can be different in all three axes. For instance, a known commercial 3D printer has a resolution of 600 DPI in X, 300 DPI in Y (in the plane of a slice, by which the machine fabricates) and 1700 DPI in Z (the build direction). Thus the size of the dot or the voxel is defined along all three axes. In other words, a voxel of the machine in its output resolution is not necessarily uniform in size in X, Y and Z.

The tessellation stage can use the desired output resolution to produce micropolygons that match the target printer resolution. Thus, as shown in the digital image of FIG. 5, a further tessellated boundary representation 510 of the bear that matches the printer resolution to be fabricated is composed of tessellations of a finer scale than those of the tesselated boundary representation 410 of the bear shown in the digital image of FIG. 4. This can be seen most clearly in the enlarged view 536 of the ear tip location 530. The tessellation stage also can interpolate user-defined attributes, such as texture coordinates, and makes them available to the later stages in the pipeline.

It is important to note that the resolution can be arbitrary. Tessellation can be conducted down to printer resolution to provide the highest possible output quality, but tessellation to that degree is not necessary. Or, the input shape can be tessellated so that the micropolygons are even smaller than the underlying printer resolution. This is useful when using displacements, since displacements may move (and stretch) the mesh substantially. By super-sampling (refining more than the underlying printer resolution), it is possible to avoid any issues with the surface being undersampled once displacements are evaluated in the surface phase of the fablet.

### Surface Stage

At the surface stage 126 of a pipeline of an invention hereof, the surface phase of a fablet program module is evaluated over the surface of the printable object. Conceptually, the fablet module surface phase is evaluated point-wise. An input to the fablet program module surface phase can be the vertex location and the normal. Output of the fablet program module surface phase can consist of a list of user-defined attributes and a displacement of the vertex. There are user attributes that are specified as part of the input (attribute per vertex). There are also user attributes that can be computed and written out as part of the surface phase of the fablet program module. The latter can later be used in the volume stage 136 by the volume phase of the fablet program module. The procedural displacement allows for increased geometric detail without a very large increase in data required to depict the geometry, and can be an especially powerful mechanism for describing surface micro-geometry (such as bear furriness) that would be unfeasible to explicitly specify in the input, due to memory constraints and the laborious process of creating them otherwise, such as by hand.

The fablet program module surface phase also has access to image textures 128, which allow texture-driven procedural effects. Image textures are explicitly defined as an input to a particular fablet binding. This allows inventions hereof to precisely track data dependencies and perform certain optimizations such as automatic creation of min-max textures for interval analysis.

The image texture that will be used in the fablet program module is explicitly defined as part of the binding information. Binding information is data that provides values for all parameters/inputs that are otherwise abstractly defined in the fablet program module. For instance, a fablet program module for a microlens array 1910, as shown in a digital image in FIG. 19, may define the height of the individual lenses 1920, as an input parameter. The value of this parameter can later be specified by the user. Similarly, the name of the image texture file that will be used in the fablet program module is not defined in the fablet. There is just an abstract declaration of the image texture. The name of the actual file used will be part of the binding data.

It could optionally be possible to allow for the fablet program module to construct the name of the image texture it will need to reference. However, this means that the execution system cannot reason about which image textures will get used and cannot make certain optimizations. In the system described above, fablet program modules can not independently decide on which image textures to load from disk. The information has to be provided at bind time.

Note also that because of the somewhat abstract way the fablet parameters are defined, the same fablet can be used more than once in a given print but different fablet bindings (couplings) with different objects may have different parameter bindings. For instance, the same fablet can be used to fabricate a bear and a rabbit, but one of them may reference an image texture that will be used to create a blackish looking bear on the surface where the fablet running on the rabbit may reference an off-white looking image texture. Which texture gets used is part of the fablet-object binding information.

An output of the surface phase of the fablet program module is a modified boundary representation 610 as shown in FIG. 6. It should be noted that while this modified boundary representation shows the modification as a displacement of portions of the surface, to simulate fuzziness, any other attributes of the boundary representation could also have been modified.

### Volume Discretization

The volume discretization stage 130 discretizes the volume enclosed by the tessellated and optionally displaced modified boundary representation 610 geometry, resulting in a representation such as at 710 shown as a digital image in FIG. 7. To volume discretize objects in a consistent fashion, it is beneficial to define rules for determining whether a given discrete volume element is inside or outside of the object's boundaries. (Voxelization is a typical type of volume discretization, and so, for brevity sake, the following discussion is couched in terms of voxels and voxelization. However, all forms or volume discretization are possible and contemplated as useful with inventions hereof. Other discretization approaches that result in a different internal volumetric representations can also be used; examples include but are not limited to tetrahedral meshes (tetrahedralization) or adaptively sampled distance fields.)

It is helpful to consider a multi-part assembly where parts are printed separately. To ensure the assembly fits together, one must follow consistent rules for defining the part boundaries. One method to do this is according to the rules of 26-separating voxelization. Alternative rules can be used as long as they are applied consistently.

### Volume Stage

In the volume stage 136, the volume phase of a fablet program module is evaluated over the volume of its corresponding object, such as the volume discretized modified representation bear 710. A goal is to create an enhanced discretized representation 810 (FIG. 8) by assigning material mixtures to all volume elements, e.g., voxels, inside the object. This part of the pipeline 110 allows for a programmed, procedural material definition, and makes it feasible to construct heterogeneous materials at the resolution of the printer actually being used. For instance, it would be possible to fabricate an object that is 100% of a first material at a top region, 100% of a second material at a bottom region, and a gradual variation in mixture from the top to the bottom, with the object middle being composed of 50% each material. This could be accomplished with a single, simple programmatic instruction of material composition linearly related to distance from one end of the surface to the other. Each available material can be given a globally unique identification ID as part of the input specification 120. Similarly to image textures 128, all materials 138 that the fablet program module will reference can be explicitly defined as part of an object-fablet program module binding. Input to the volume stage 136 can consist of the center and size for a voxel. Output can be a list of pairs of: a material; and a quantity (for that material, as discussed above). The output quantity values are normalized to completely fill the voxel volume. If the output is empty, the voxel is marked as void. The output is an enriched discretized volume representation 810, enriched by having materials assigned to each of the volume elements. Normalization of output can be enabled or disabled by the user. If disabled, it is the user responsibility to make certain that the quantities of the different materials add up to 100%.

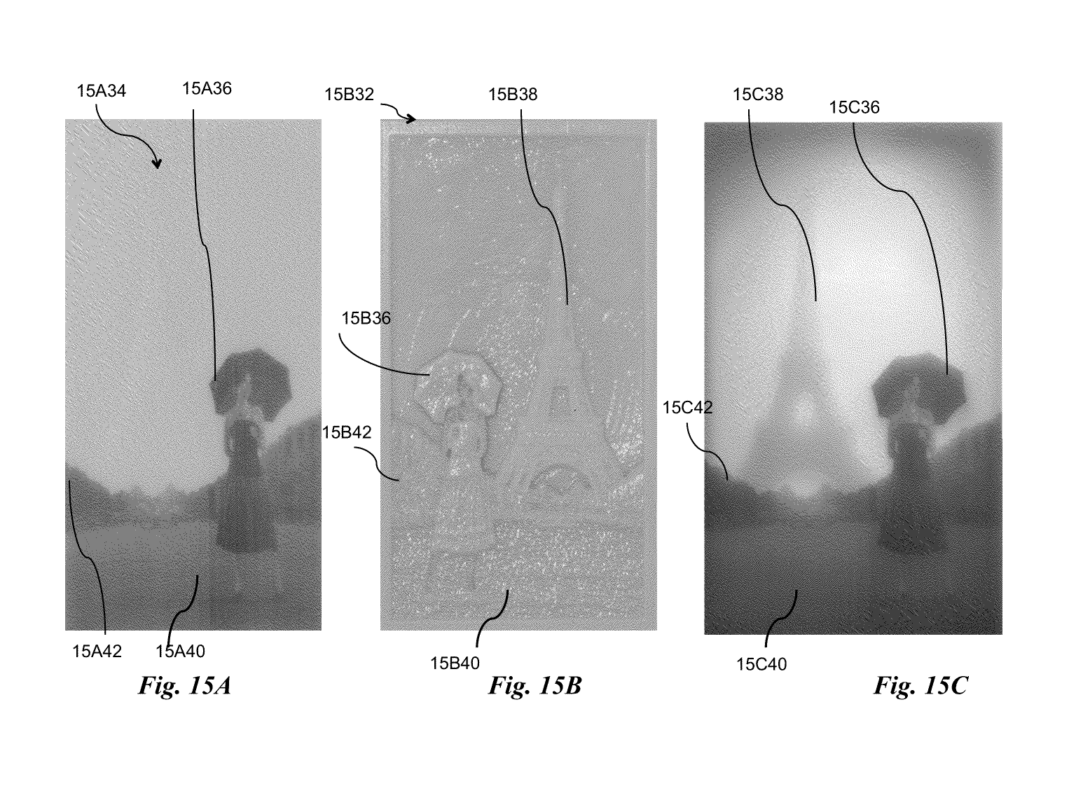

When defining materials volumetrically, it is often useful to be able to determine the relative position of a given voxel with respect to the object boundary. It is helpful to consider a scenario where it is desired to print an object to which an image texture has been mapped. It is not useful to assign a feature, such as a color, simply to the outer layer of the surface. To achieve a particular color, reflectance, and scattering behavior, a 3D printer needs to deposit an appreciable amount of layered material to a sufficient depth, to achieve the desired appearance properties. Thus, a key feature achieved in the volume stage 136, by the volume phase of a fablet program module, is a routine that can query the distance to the nearest point on the surface. Similarly, in the volume stage, using the surface phase of a fablet program module, the user can query any user-defined surface attribute or any values generated by the surface stage 126 at the same point. These techniques are both discussed below in connection with FIGS. 15A, 15B and 15C.

### Dithering

As discussed above, the output of the volume stage 136 includes a blend, or mixture of materials for each volume element, as shown at FIG. 8, 850. Thus, such a representation 810 can be referred to as a blended material representation. However because 3D printers typically are only capable of depositing a single type of material at a given point (voxel), it is necessary to transform this blended description of the material mixture into a dithered representation 910, such as shown at FIG. 1, such that only a single material assignment is provided for each printer addressable voxel. The dithering challenges are unique to 3D printing of multiple materials, and are significantly different from any dithering performed for color 2D printing, or for any aspect of 3D rendering that requires dithering.

One of several key challenges for 3D dithering, is that the number of materials for a 3DP application is potentially much larger and the dithering should ideally be performed in three dimensions, rather than simply in 2D. The fact that three dimensions are involved rather than two complicates the dithering to a much greater degree than might seem from the fact that only one dimension is being added. In fact, this greatly increases the degree of interaction of the material deposited at a single spot. In a two dimensional rendering situation, the material of a specific spot interacts visually/optically with its neighbors in four adjacent locations: two on either side along a first dimension, and two on either side along the second dimension. For three dimensions, the material must interact with materials in these same four directions, along with two additional locations on either side of the dimension orthogonal to the first two.

Further, as discussed below, the type of interaction can be much more complex than simply the effect on an optical phenomenon, such as visually perceived color. In 2D printing or 3D rendering, any dithering usually relates to color combination, or perhaps a few additional limited visual phenomena. For color combinations, there are typically only three or more different primitives to choose from, depending on the color system (RGB, CMYK or some equivalent), although there are some color systems that dither among more than four components. However, with 3DP fabrication, the interaction can affect many different phenomena other than simply visual, and, in particular, color, including but not limited to: all of the visible aspects of 2d and 3d rendering, including miscibility and/or mutual solubility of adjacent materials, chemical reactivity/passivity, physical compatibility of shapes of materials at a sort of crystalline level, e.g., spherical particles pack together differently from needle types; liquid absorbability, flexibility, electrical properties and different expansion and contraction properties among materials.

### Output

The final output of a pipeline 110 of an invention hereof can be a general-purpose, streaming raster slice format. Vendor or device-dependent back-ends can be implemented that take this input and transform it into device-specific print commands such as for a specific 3D printer, such as 152a, 152b, 152n. Different back-ends can be implemented for different printers 152a, 152b, 152c, etc. A practical implementation in many instances is a streaming raster slice format that is appropriate for a drop-on-demand type 3D printer, however, drop on demand is mentioned only by way of illustration and is not to be taken as limiting in any way.

As has been mentioned above, the range of sizes and resolutions of objects that one can 3D print is very wide. Recent work on nanoscale 3D printing has demonstrated the ability to print 3D objects at resolutions as high as 100 nanometers/voxel, whereas very large format 3D printers exist whose build volumes are measured in hundreds of cubic feet. For instance, the build volume of the VoxelJet VX4000 occupies on the order of 100 trillion voxels. Thus, the amount of data that will be required to specify output objects for such machines is unprecedented. The pipeline architecture and program module based methods and apparatus described above will be able to handle these vast data requirements, because the projects can be broken down into smaller segments, slab by slab. Output can be streamed to the output machine for the first-to-be-built slabs, while the output data to be used for subsequent-to-be-built slabs is being independently generated at a different stage of the pipeline and/or awaits generation at an even later time, but still while subsequent slabs are being printed.

### Example Implementation

The foregoing has described overall stages of a pipeline implementation of an invention hereof, particularly as such a pipeline (either in terms of method steps or hardware arrangement, or both) is seen from a user's point of view.

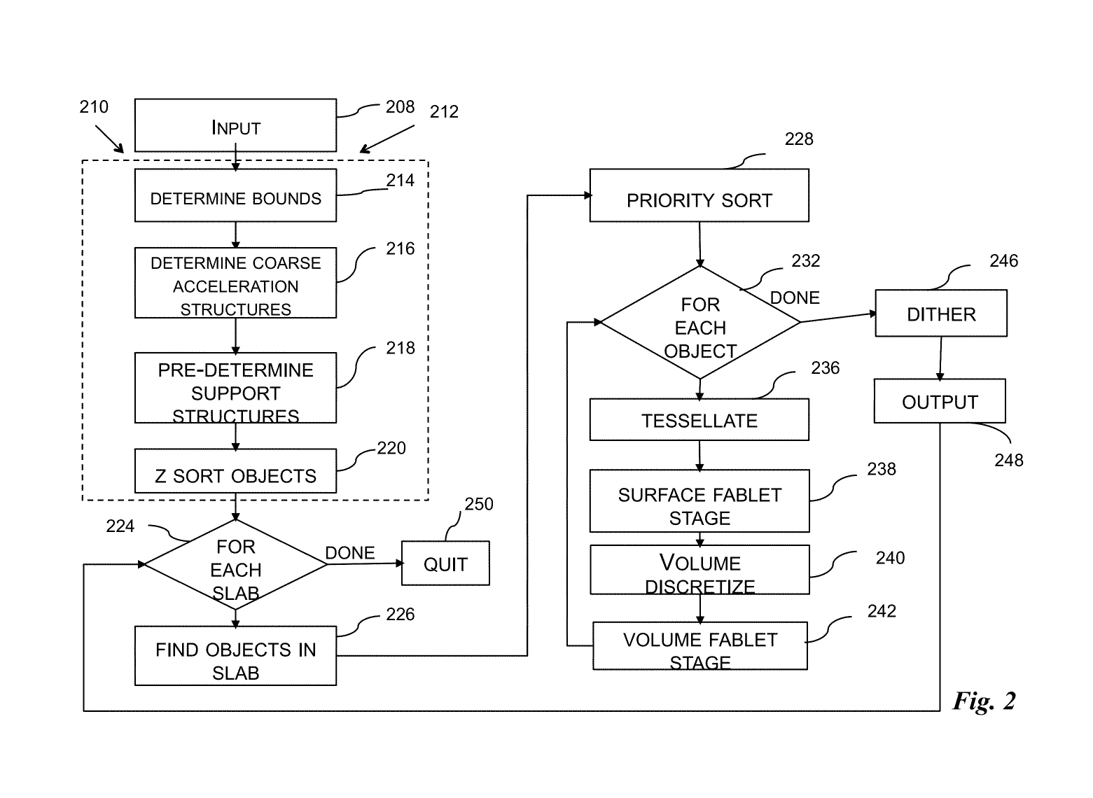

A prototype implementation has been built to stream output with a fixed memory budget and low startup time. It is a scalable foundation for a high performance implementation. It is more than fast enough to keep up with currently available printers, even though many individual stages are not internally optimized. Representative steps of a suitable implementation are shown schematically in flow chart form in FIG. 2. Representative items fabricated using such an implementation are also discussed below.

The steps that are performed can be considered in several conceptual groups, including: pre-computation steps 212; steps conducted 224 for each slab (a slab loop); within the subject slab, steps conducted 232 for each object (an object loop).

### Pipeline Stages

The user provides inputs, as discussed above, including a specification of the object to be fabricated, fablet program modules, material sets, etc. Bounds are determined 214 for each object in the fab graph. Users provide maximum displacement bounds, but it is helpful to additionally use interval arithmetic to automatically determine those bounds as well. To determine the maximum displacement, it is possible to execute an interval variant of the surface phase of the fablet program module bound to each shape. It is appropriate to choose the minimum of the user-provided and system determined bound. Interval analysis for conservative bounding of computed values is useful for bounding surface displacements and adaptively sampling the material volume in three-D fabrication.

Standard compiler transformation techniques can be used to automatically generate a variant of the surface phase of the fablet program module that works on intervals. When determining maximum displacement bounds, bind all of the parameter data can be bound to the interval variant of the fablet program module, and just-in-time compilation (JIT) is performed and the bound fablet program module can be executed using the interval described by the input geometric shape. The interval can be defined by the range of the 3D coordinates of the geometric shape. All additional inputs can be converted to intervals if needed. Sampling of image texture data can be replaced with intervals of possible values within the referenced image texture. To optimize the execution of this interval fablet program module, interval variants of all referenced image textures can be created, which is a process similar but distinct from creating mip-maps for image textures.

It is beneficial for a volume phase of a fablet program module (which is executed at a later stage 242) to make nearest surface point queries. Such queries are expensive to compute on demand. It is beneficial to create 216 in advance acceleration structures to speed up the queries performed 242 in the volume phase of the fablet in the volume stage 136 shown in FIG. 1.

An example acceleration structure is a bounding volume hierarchy (BVH), which spatially partitions the input shapes. It is useful to conservatively account for possible displacement using the displacement bounds calculated in the prior stage 214. The BVH is refined until each sub-volume contains no more than a given target number of candidate primitives (e.g., triangles or quadrilaterals). This up-front process is performed on the un-tessellated input shapes, and thus, it is very fast.

On query, a second-level BVH can be built. The surface phase of a fablet program module is then evaluated so that the actual displacement is performed. Results can be cached, e.g., in a Least Recently Used (LRU) cache.

Many types of 3DP techniques, including Drop-on-demand 3D printers, FDM and traditional stereolithography fabrication devices require support material to be placed underneath parts of the printed object that do not lie directly on top of previously created physical layers. The support material is eventually removed from the final product. Thus, a pipeline control invention hereof determines 218 the form of these support structures. It also instructs the printer to place them at the very beginning of the print process, typically in the first slab, or, at least, a slab that precedes the slab in which the supported structure resides, regardless of the eventual position of the part that relies on them.

Not all target printers require support structures. However, if the target printer does, it is important to pre-determine 216 the places where such support is needed. One way to do this is to use a fast, high-resolution, fixed-point rasterizer to perform an orthographic render along the print platform movement axis (typically, the negative vertical, z, axis). The following concepts are illustrated with reference to FIG. 13, which shows a vertical cross-section of the primitives to be printed. Each addressable printable primitive location is represented by a single square. The primitives that represent the portion of the object to be printed in this section are designated 1320 (and are hatched diagonally, indicated by the finest hatching. As can be seen, the object 1320 to be printed has several overhangs—one on its left side, mid-height, another on the right side also at mid-height, and a second on the right side, at about one-third height. Each primitive is dilated (as explained in more detail below) to account for any possible displacement using the bounds determined in the bounds stage 214. For the object depicted in FIG. 13, only one primitive 1322 is affected by such dilation. It is indicated by a diagonal cross-hatching slightly less fine than that for the object 1320. The resulting depth map can contain the highest point along the z axis at which material is present for each voxel column represented by that given depth sample. A voxel column is a column of a single voxel in the section in width and depth, extending the full height of the section sample, in the direction of the arrow C, as shown below several columns. Sixteen voxel columns are shown in FIG. 13. After dilation, the highest point on the shape in the column is determined, for instance using a depth render from the top down. Such highest points 1324 of the object in a column are shown in diagonal cross-hatching that is slanted oppositely to that of the basic object 1320, and coarser than the dilated block 1322. During the output stage, discussed below, if a given voxel 1326 is void, (no cross-hatching support material 1328 (diagonal cross-hatching of the coarsest degree shown) is output if and only if the height (z-value) of that voxel is lower than the highest populated voxel for that particular voxel column, as recorded in the depth map. This can be seen in FIG. 13. When the final voxels are sent to the printer, any empty voxels that are underneath the depth-buffer voxels 1324 are filled with support material 1328. When printing with soft materials that may not be self-supporting vertically without adjacent or sub-adjacent support, it is beneficial to additionally create support structures on the sides.

A comment may be helpful to further explain FIG. 13. Support information is calculated at the very beginning of the pipeline before volume discretizing stage 240. FIG. 13 shows, schematically, a voxelized space, although at the point when support is determined 218, the input shape is still a polygonal or smooth mesh. The intent of the FIG. 13, is to show what happens once there is a voxelized representation. The system identifies the voxel columns that need to be filled with support material so that they can support overhangs. Those columns are identified by rendering from the top looking down. The input primitives (triangles, quads, etc.) are rendered, and the height at which they occur is recorded. Since these primitives can move due to displacement in the fablet program module, the mesh is dilated (by which it is meant expanded) by moving the primitives outward using the maximum displacement bound that was either calculated using interval analysis or provided manually by the user. This provides a conservative bound for the overhangs.

To progressively fabricate each object along the print (z) axis, the candidate objects are sorted 220 into a priority queue. The minimum z value of their bounding boxes can be used as sort keys. Each object is then retrieved from this queue when the slab being processed begins to intersect the bounding box of the object.

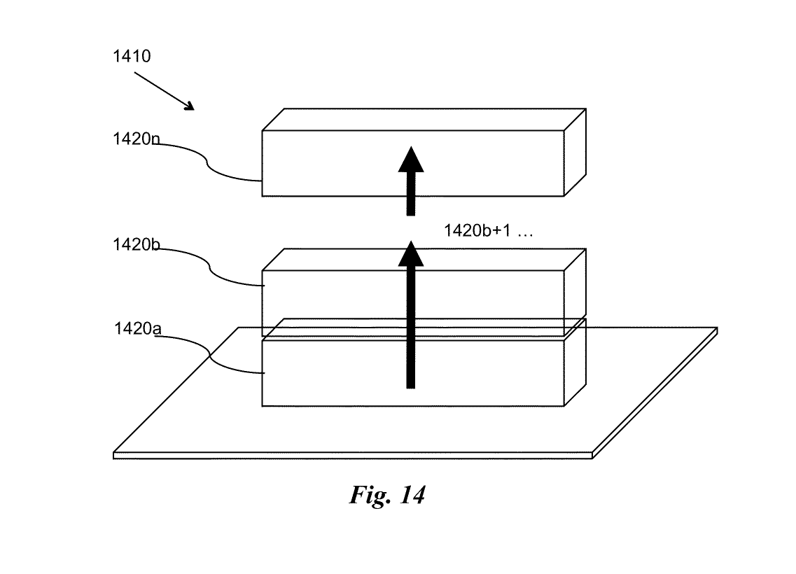

As shown schematically in FIG. 14, the print volume 1410 can be divided into n slabs 1420a, 1420b, 1420C, . . . 1420n. The size of a slab can be dynamically determined based on target memory usage, and can beneficially be a function of the resolution of the printer and the total build volume. Each slab 1420a, 1420b, etc., is processed 224, as shown in FIG. 2 by a loop.

As each slab 1420n is processed, a working set of objects is maintained, whose bounding volume intersects the current slab 1420n. As the processing of each slab begins, the working set is updated 226 by removing objects that are now beyond the current slab and adding objects that are now within the current slab's domain (the combined acts of removing and adding being referred to as finding at 226 in the flowchart). When determining which objects intersect the current slab, it is useful to take into account the maximum displacement of the object. Thus the intersection is done using conservative bounds.

Returning to FIG. 2, it will be recalled that each object has a user-provided priority that determines which object should be considered to occupy a given voxel in case of an overlap between two or more objects. Because the priority is assigned on a per-object basis, the objects can be pre-sorted in advance. Thus, all objects in the working set are sorted 228 based on their priority value. When voxelizing and populating the voxel buffer, if a given voxel is already occupied, the newly arriving voxel can be immediately discarded, giving opportunities for early culling. Culling voxels due to object overlap makes fablet program module evaluation efficient: only one fablet program module (the one assigned to the highest priority object) gets evaluated per voxel.

For each object in the working set, the method steps iterate 232, in order of object priority, the following steps: tessellate 236, surface phase of fablet 238, volume discretize 240 and volume phase of fablet 242. These have been discussed above, in outline, and are discussed below in more detail.

The first stage in the object loop 232 is partial tessellation 236 to create a tessellated boundary representation 410 (FIG. 4) of the portion of the object that is within the current slab. Regardless of the object type, it is beneficial to always tessellate into micropolygons, which can beneficially be the common 3D primitive for the remainder of the steps of the method pipeline. It also enables filtered texturing. In order to determine the area that a given image texture sample covers in texture space, texture derivatives can be determined by looking at the sample locations on neighboring vertices on the surface. The derivatives are determined by using forward differencing on the vertices of the micropolygons. A tessellated object can be cached and reused if the object straddles multiple slabs. Objects can also be tessellated on demand to respond to a distance function or nearest user attribute query; such tessellations can also be cached and reused. The cache has a set size and entries can be evicted, for instance using an LRU scheme.

The surface phase of the fablet program module bound to the object under treatment is evaluated 238 on the resulting tessellated mesh and produces a modified boundary representation 610 (FIG. 6). It is useful to evaluate a micropolygon at a time to determine derivatives and thus determine the filter width needed for filtered sampling of textures.

A representative fablet program module is presented and discussed below, after the discussion of the flow chart FIG. 2.

Volume discretization, such as solid voxelization is conducted 240 and produces a volume discretized modified representation 710 (FIG. 7). One suitable method is an odd-even rule (such as using the Jordan curve theorem). A ray can be cast along one of the principal axes and for each micropolygon hit, an inside/outside bit can be flipped for all voxels behind the hit. For each hit within a given voxel, one need only consider that voxel to be inside the mesh if the center of the voxel is in front of the hit, thus establishing a voxelization ordering rule that guarantees consistent behavior. More efficient hierarchical edge-equation based voxelization techniques exist, and it is believed that they would provide useful results. Alternatively, other volume quantization techniques, including but not limited to tetrahedralization can be used.

The volume phase of the fablet program module is evaluated 242 for each volume element, such as each voxel in the three dimensional voxel grid to produce a volumetric representation 810 (FIG. 8) of the material composition. The underlying volume element grid in a present implementation can be optimized to store up to 16 materials out of a total of 64 materials that can be defined in the fab graph. Careful consideration for keeping the memory footprint as small as possible is beneficial. If additional memory is available, these numbers can be increased.

Surface distance and attribute queries can be evaluated on demand when needed by searching the corresponding acceleration structure determined 216 earlier. To allow fast startup, the acceleration structure can encode the original input objects (expanded conservatively to account for displacement bounds). At search time candidate base primitives can be tessellated and displaced by the surface phase of the relevant fablet program module, and their microgeometry recursively searched for the nearest point or attributes. The results of tessellation 236 and fablet program module surface phase evaluation can be cached in a post-tessellation surface cache, so that they are rarely recomputed. The cache size limits potential memory overhead at the cost of redundant recomputation of surface geometry required in multiple places.

Dithering 246 can be done in various manners to produce a dithered representation 910 (FIG. 9). One suitable manner is to use a modified 2D Floyd-Steinberg-like dithering for each slice when using multiple materials. A slab may be composed of one, but typically of more than one slice. Unlike Floyd-Steinberg which only deals with three components of color, we use a generalized form of the method in order to handle an arbitrarily long list of materials at each voxel. A sliding window can be used to satisfy any fixed memory requirements and reduce storage pressure for large slabs. Dithering can be performed on a grid of the same resolution as the voxelized grid. Any errors due to the difference in final effective resolution is distributed around the local neighborhood. Error diffusion achieves the right balance.

Alternatively, 3D dithering can be performed within the slab as long as the slab is more than one slice thick or/and one or more slices of the previous slab have been cached. 3D dithering is then performed across two or more neighboring slices (along the Z, build axis) within a local 3D neighborhood. 3D dithering can be advantageous because it can reduce an appearance of streaking along the vertical axis.

The dithering stage can also be programmable, such that the user supplies a dither program module that implements the dithering scheme for a particular fabrication job. A user provided, sized, local neighborhood of voxels and their assigned blended material composition, which resulted from the volume phase of the fablet, is provided to the user-provided dither program module. The dither program module can output the final discrete, single material dithered assignment of materials as shown at 910 in FIG. 9. The user provided local neighborhood corresponds in size and location to the neighborhood in which the single material, dithered assignment of materials. The correspondence can be exactly identical, or, more typically, different in a recognized manner, depending on the number of materials and sizes of the volume elements.

If the volume phase of the fablet program module 242 consistently generates only a single material at any voxel while still using multiple materials, the result of the dither stage 246 matches the resolution of the printer. If the volume phase 242 of the fablet program module outputs blended multiple materials, at one or more voxels, to produce a dithered one-material per voxel representation, such as shown at 850 FIG. 8, the dither stage 246 can gracefully reduce resolution to achieve the material ratios requested. By gracefully reducing resolution, it is meant that the system progressively lowers the resolution as the number of materials nominally used at the same location is increased. The printer has a finite, well-defined resolution. If a single material is specified at each voxel (of the printer's resolution), the dithering stage will essentially leave the data unmodified, i.e., it will simply assign the input material to the final voxel. However, if a voxel has more than one material assigned to it, such as indicated at 850, FIG. 8, the dithering stage will distribute those voxels within the local neighborhood. The more materials that are used, the more neighboring voxels will be needed to spread those materials. Thus, as the number of materials increase, resolution is lost. The higher the number of materials—the less resolution can be achieved.

The result of the output stage 248 can be in various formats, including but not limited to a raster format. Various formats and corresponding machines are indicated at 152a, 152b and 152c of FIG. 1.

### Resolution Independence

Procedural synthesis of surface and volume detail provides resolution independence for different output sizes and resolution. By programmatically specifying surface displacements in the surface phase of the fablet program module, the user can procedurally specify fine surface detail without manually refining the geometry, scaling it and displacing it for a particular target print resolution. Simply by virtue of tessellating the surface at a different rate and evaluating the surface phase of the fablet program module on the resulting surface, one can sample the displacements at arbitrary target resolutions. Similarly, by programmatically specifying the material composition (via the use of the volume phase of the fablet), the fabrication process has the freedom to sample the material composition at arbitrary resolutions. If one printer can only print at 100 dots per inch resolution, it means that the evaluation of the material composition can be done on a voxelized grid that was constructed at such resolution. Another printer that can print at higher resolution can evaluate the same fablet program module with a grid of different resolution with no user intervention.

### Example Fablet Program Module

To understand how fablet program modules can be used to programmatically define surface detail and continuous volumetric material variation, it is helpful to consider the example as shown schematically with reference to FIGS. 15A, 15B and 15C, which show an item which, if made by other methods, would be conventionally known as a lithopane, but, which was made using inventions disclosed herein. This item involves a picture, which in the present example, is in two components, which added together make up the whole. One component, referred to herein as a foreground picture shows a woman with a parasol standing on a lawn with a receding line of trees behind her. The second component, referred to below as the background picture, consists only of the Eiffel tower. It is not visible in FIG. 15A. A first side, shown by digital image in FIG. 15A is flat and texture-mapped (discussed more fully below) with the foreground picture, showing the woman 15A36, lawn 15A40 and line of trees 15A42. The other side, shown by a digital image in FIG. 15B, is displaced from a nominal planar boundary surface, according to the brightness of the same foreground picture of the woman and lawn and trees, and also superimposed thereon, the background picture of the tower. This lithopane-type object (referred to informally herein and in the fablet program module, as a MagicPostcard) is defined by the fablet program module below. It was fabricated starting with the flat, front face, and ending with the displaced, rear surface. However, it could have been fabricated in the reverse direction (although in that case, support material would have been required. It could even have been built up from the bottom to the top, i.e., from the woman's feet to her head, but then, also, some sort of supporting scheme would have been required.)

TABLE 1
LITHOPANE FABLET PROGRAM MODULE

```
fablet MagicPostcard {
  @uniform {
    float2 border;
    float textureDepth, maxThickness;
    ImageTexture2D fg, bg;
    Material white, black;
  }
  const int CARD_FRONT = 0, CARD_BACK = 1;
  @Surface(@varying {
            SurfaceAttributes attr,
            float2 uv, int face,
            out float2 uvOut, out int faceOut
            })
  {
    // pass through attributes
    uvOut = uv;
    faceOut = face;
    if (face == CARD_BACK) { // back face
      float L = bg.Sample1(uv[0], uv[1], 0);
      float thickness;
      if (uv[0] < border[0] || uv[0] > 1 − border[0] ||
          uv[1] < border[1] || uv[1] > 1 − border[1]) {
        thickness = maxThickness;
      } else {
        // material approximation: transmission
        // has quadratic falloff with thickness
        thickness = sqrt(1 − L) * maxThickness;
      }
      return attr.n * thickness;
    } else {
      // no displacement on the front and sides
      return 0;
    }
  }
  @Volume(@varying {
          VolumeAttributes attr,
          @nearest float2 uv,
          @nearest int face
          })
  {
    MaterialComposition mc;
    if (face == CARD_FRONT && // front face
        abs(distance(attr.voxelCenter)) <= textureDepth) {
      // surface texture
      float L = fg.Sample1(uv[0], uv[1], 0);
      mc.Set(white, L);
      mc.Set(black, 1 − L);
    } else {
      // background/border
      mc.Set(white, 1);
    }
    return mc;
  }
}
```

In general, material and image texture handles are declared as attributes of the fablet program module, along with parameters for the dimensions of the rectangular border 15B32, maximum thickness as well as the depth into the volume to which the texture should be deposited on the front face 15A32.

The surface phase (beginning with the fablet program module text @Surface) can take as arguments the position, normal, and texture coordinates defined over the mesh, as well as a per-vertex enum-like flag, indicating the face of the cube (front, back, or side). If the currently processed vertex is on the back face, the fablet program module can beneficially determine a material thickness based on the luminance of the combined foreground and background picture and displaces the mesh accordingly. It creates a fixed-depth border 15B32 in a narrow band around the edges defined by the BORDER parameter. Outside the back face, (i.e., deeper within the object than on the back face) it performs no displacement and simply returns the original vertex position. Thus, a result of the surface phase displacement, is that all of the points of what might, without any displacement, have been a planar, back face, are displaced in such a way as to create a sort of bas-relief, topographically varying replica of the combined foreground and background pictures, with the degree of topographical (surface) displacement (and thus the total thickness of the entire created object) corresponding to the inverse luminance values in the picture—the higher the luminance value, the less thick the relief is. As thickness increases, light transmittance decreases so when the lithopane is back-lit, the thicker regions produce darker images. Bas-relief structures corresponding to the woman 15B36, lawn, 15B40, trees (barely visible at 15B42) and tower 15B38 can be seen. These luminance values are the contents of the image texture that is an input to the fablet program module.

The following comment is provided for clarity and also possibly for the understanding of those not fully versed in the terminology of digital rendering of three dimensional objects and scenes and also 3DP printing of three dimensional objects. A result of building the object under control of the surface phase of the fablet program module is a bas-relief surface that is itself topographically textured. This is not the kind of texture that is meant herein when the term image texture is used. The word texture is not used herein intentionally to mean a topographical variation. Further, the phrase image texture is used herein to refer to various forms of information that can be represented in what is known in data processing industries as an image, which can be a look up table in 1D, 2D, or 3D of values, which are used by the 3DP printer to take some action. In this case, the image texture represents the combined picture of the foreground (woman, lawn and trees) and the background (Eiffel Tower) and it records. These image texture values are used by the volume phase of the fablet program module to determine which of two materials are to be deposited in each printable voxel. Thus, they relate to a variation, a texture, of sorts, in the material placement. But, there need not be any topographical variation associated with the image texture. There could be, as there is in this case, because one of the uses is to govern the thickness of the overall product, but there need not be. And the other use, to govern the degree of dark and white material printed near to the front face, is not a topographical variation.

The volume phase of the fablet program module, (which begins with the text @Volume) takes as its argument the 3D position of the center of the currently processed voxel. It then uses the FACE flag from the nearest surface point to determine if the currently processed voxel is near the front face (which is the face shown in FIG. 15A). If it is and the DISTANCE to the surface is within (less than) TEXTUREDEPTH, it samples the foreground picture image texture based on the nearest surface texture coordinates, and mixes black and white materials based on the brightness at that point. Thus, to a depth equal to TEXTUREDEPTH, repeated instances of the picture visible in FIG. 15A are recreated in black and white materials. The image texture cannot simply be deposited in an infinitesimal layer on the surface, because this would be insufficiently noticeable. To show up clearly in real materials, it is usually necessary to deposit colors down from the surface to some depth inside the interior volume. Elsewhere in the object, it outputs plain white material.

The back surface is not only displaced to a degree to replicate the foreground picture of the woman 15B36 and the lawn 15B40 and trees 15B42, visible from the front in FIG. 15A, but it is also displaced to also increase the total thickness in corresponding degree to the inverse luminance that corresponds to the Eiffel tower 15B38, seen in FIGS. 15B and 15C. The tower is not part of the foreground picture that constitutes the image texture used for determining the amount of black and white material used to create the volume near the front face. The regions of the object that constitute the Eiffel tower 15B38 are thicker than other regions, in a manner that corresponds inversely with its luminance. When a light is shown from the back face 15B34 towards the front face 15A34 and the object is observed from the front, the additional thickness of the Eiffel tower regions 15B38 blocks the transmission of light therethrough, and a shadow 15C38 in the shape of the tower appears. The rear surface displacement corresponding to the woman 15B36 and the lawn 15B40 and trees also contributes to the appearance of these items as dark shapes 15C36, 15C40 in the backlit view shown in FIG. 15C. Their visibility, as discussed above, is also due, in part, to the proximity of black material to the front surface, at the locations that correspond to the picture of the woman 15C36 and lawn 15C40 and trees 15C42.

It will be understood that, by simply changing the picture data, in general to that which relates to another, different picture, an entirely different lithopane-type object could be made, with different back face displacement and different thicknesses throughout, as well as a different picture visible from the front surface. Reallocating the woman to the background picture and the tower to the foreground picture would change which of the two are visible without and with backlighting. Such changes require relatively minor effort, but, due to the programmatic, procedural nature of the surface and the volume phases of the fablet program module (both of which play a role in the shape, appearance and optical properties of the produced object), such minor input changes can produce very significant changes in the fabricated object.

Another example of a fablet program module of an invention hereof is set forth at Table 2 and is discussed below.

TABLE 2
Volume Fablet Program Module Global Query.

```
fablet MyFablet {
  @uniform Material red, blue, yellow;
@Surface(...) {
  return double3(0, 0, 0); // no displacement
  }
@Volume(@varying double3 voxelCenter) {
  MaterialComposition mc;
  const double layerThickness = 1;
  double dist = distance( );
  if (dist <= layerThickness) {
    mc.Set(red, 1);
  } else if (dist <= layerThickness * 2) {
    mc.Set(blue, 1);
  } else {
    mc.Set(yellow, 1);
  }
  return mc;
  }
}
```

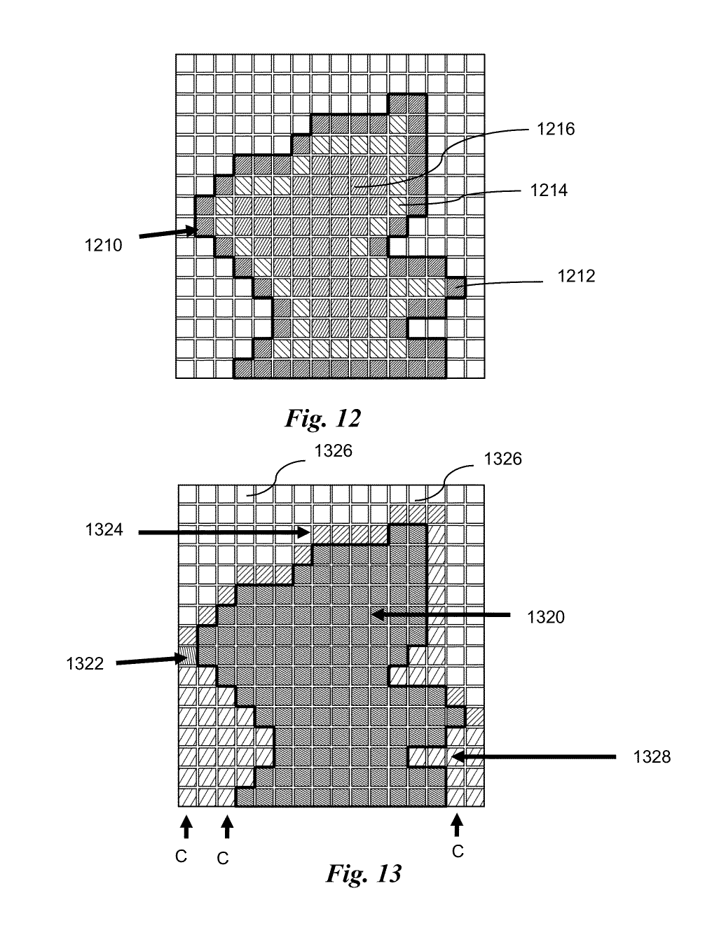

The volume Fablet Program Module set forth in Table 2 above is similar to part of the fablet program Module discussed above in connection with the lithopane of FIGS. 15A, 15B and 15C, and will be explained with reference to FIG. 12, which is a schematic representation of a vertical cross-section of an object being fabricated. A common scenario is to print objects made of layered, composite materials (for instance similar to an onion, where different layers are of different materials). An efficient way to describe such a material composition is to use a signed distance function, so that at every voxel the user can choose exactly what material to place, given the distance from the nearest point on the surface. Consider the object 1210 shown in heavier line outline in FIG. 12. Assume that it is desired to fabricate the outer layer 1212 of the object from a first material, for instance, a red material (indicated by finest spacing of cross-hatching), the inwardly next layer 1214 from a second material, for instance, of blue material (indicted by the coarsest degree of cross-hatching) and the most interior, next layer 1216, to be made of a third material, for instance a yellow material (indicated by cross-hatching of intermediate coarseness). The fablet program module instruction code, shows that it is sufficient to query the distance from the voxel in question to the surface, and then to conditionally assign the proper material, based on the outcome of the query as compared to several limits: for instance, a limit layerThickness=1, and also layerThickness*2. Comparing to these two limits with a concluding, else operation, is sufficient to establish three different materials at the desired distances from the surface. The fablet program modules also provide an ability to query attributes defined on the surface from the nearest point on the surface. These attributes can consist of texture coordinates or any other user value specified on the input mesh.

### Example Fabrications

A variety of different objects have been designed and fabricated, which highlight features of pipeline and programmatic, procedural module method and apparatus inventions hereof.

Objects have been printed on an Objet Connex 500 printer, available from Stratasys, Ltd., having a principal place of business in Eden Prairie, Minn. 55344, a high-end multi-material 3D printer, which uses photopolymer phase-change inkjet technology and is capable of simultaneously printing with two primary materials and one subsequently removable support material. It supports a variety of polymer-based materials that vary in color, elasticity and optical qualities.

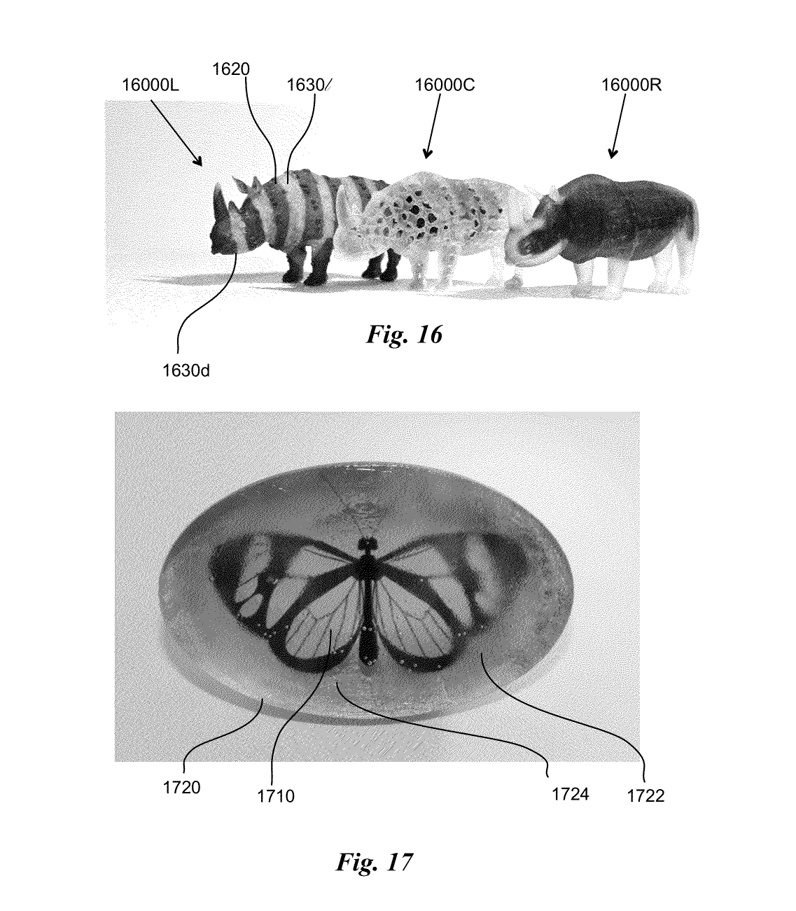

One example highlights the ability to easily apply different fablet program modules to the same base geometry. Multiple objects of the same shape can vary significantly in appearance or behavior due to the choice of materials of which it is made of. Each can use a variety of features. For instance, as shown in FIG. 16, for the rhinoceros 1600L on the left hand side, one can use displacement mapping in the surface phase of the fablet program module to create micro-spikes or bumps 1620 over the skin. (This is a similar feature to that described to generate a fuzzy fur appearance to the bear 610 of FIG. 6 although that is a digital image of an internal geometric representation of the product to be made, not the printed, physical item.) The volume phase of the fablet program module samples from a 2D zebra stripe-like image texture of alternating dark 1630d and light 16301 colored regions (stripes) to apply a layer of black and white material near the surface, in a similar manner as the foreground picture of the woman 15A36 and lawn 15A40 and trees 15A42 is applied near the front face surface 15A34 of the lithopane. The volume phase of the fablet program module queries the nearest point to retrieve the texture coordinate necessary to sample the image texture. It also queries the distance to that point to determine whether to apply the (color) textured material. The region near the surface is colored; the core of the rhinoceros can be made of only white material.

As shown by digital image of FIGS. 10A and 10B, the bear 10A10 has holes (channels) 10B20 passing throughout its body (most easily visible in FIG. 10B, which views the channels from their ends, which are open) by returning void in the volume phase of the fablet program module for the material to be used at locations of the channels. There is also a relatively transparent outer shell 10B22 and a black inner core 10B24. A distance query function was used to separate the transparent outer shell 10B22 of the bear from the black inner core 10B24.

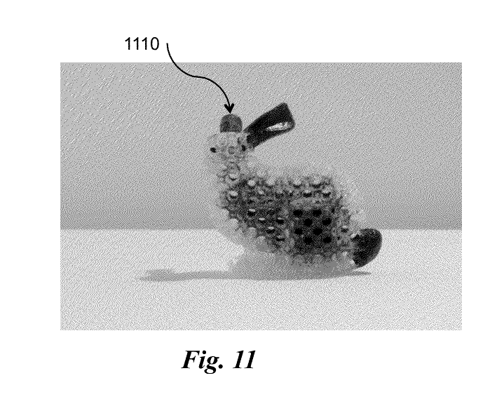

This same overall appearance of the bear 10A10 shown in FIGS. 10A and 10B has been established in the rabbit 1110, FIG. 11, by: using a surface geometry of a rabbit, and then using for the volume phase of the program module, the same instructions as were used for the bear 10A10, with channels that return void for the material for locations of the channels. Thus it can be understood that the shape/geometry (bear or rabbit) of the object is independently specifiable from the material description (channels, internal black, exterior transparent, alternating striped volumes of dark and light materials, etc.). The rhinoceros 1600R on the right hand side is fabricated using yet a slightly different volume phase of fablet program module with different distance functions that separate the transparent, or light color material from the darker material.

The overall shape of the object is defined in the input stage 208. The fablet program module specifies where material is to be placed, and what type, by procedural routines based on distances from the outer surface. It matters not what the actual shape of the outer surface is. Thus, such a fablet program module, provided with a surface geometry input (akin to that shown at 310 for a bear in FIG. 3), but that represents a rabbit FIG. 11 will create a rabbit with a dark inner core, a transparent outer region, and channels throughout.

A fablet module for the amber item includes within it, functions or other programmatic elements that generate a variation in materials such that they appear cloudy (by mixing darker and lighter materials or materials of varying degree of transparency), at locations generated either by randomness or some function or pattern, and also voids that appear as bubbles, and also more concentrated darker regions that appear as particles (as opposed to just cloudiness). Again, a few simple variations in the programming portions—for instance increasing the size parameters for the voids, or their spatial frequency parameters, and/or the cloudiness, can have a significant effect on the appearance and structure of the final item.

Another effect can be achieved using a material that is flexible but volume-preserving to print such objects. A fablet program module can introduce procedurally-defined and repeated void spaces (such as shown at the channels 10B24 of the bear 10A10, or the rabbit 1110 (FIG. 11), to achieve a compressible, foam-like material. If a flexible material is used for the non-void portion of such a channeled item, then the entire item is flexible, like a sponge. This demonstrates another ability to easily define and apply patterned materials.

One could also make the 2D or 3D pattern described above in connection with a foam like object, be image texture-driven.

Thus, some geometries, for instance spaced apart voids, can be produced either by a volume phase that establishes a pattern of material and voids based on a procedure, involving size of voids, spacing, etc. Or, alternatively, such a pattern of voids can be established by mapping from an image texture that is a pattern of material and voids, or two or more materials, and mapping that image texture pattern to locations within the object to be made. Both techniques specify the geometry programmatically (the user writes the fablet program), but one is procedural because a procedure describes exactly how the pattern is formed. The other is more data-driven, i.e., the pattern is created from the data sampled from an image texture. A pipeline invention as described herein allows one to build a library of such fablet program modules, which can be reused and modified, shared, disseminated, edited easily, etc.

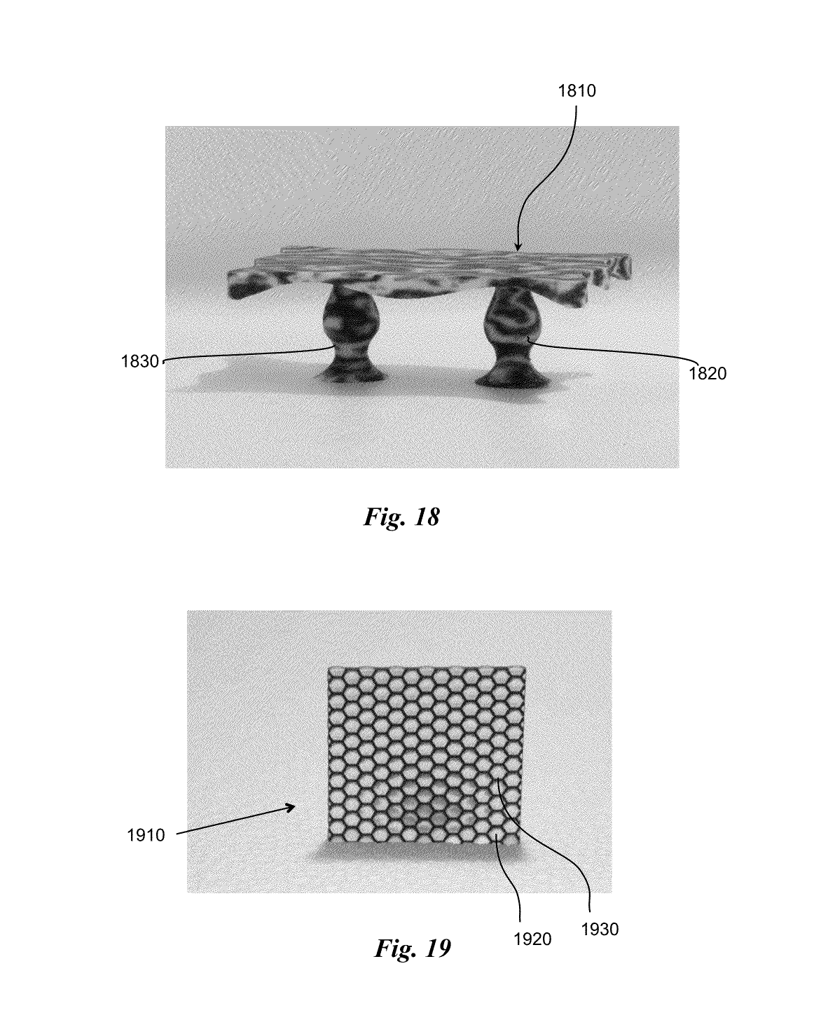

It would also be possible as shown with a digital image in FIG. 18 to procedurally create the appearance of marble, for instance in a table 1810. Such a fablet program module can use a pseudo random data generator, such as Perlin noise in the volume phase of the fablet program module to describe a marble like pattern not only on the surface, but also throughout the volume of the table. In such a case, the material distribution changes continuously to create a graded material, in this case of two materials of dark 1820 and light 1830, but more materials than two could be used.

FIG. 19 shows a digital image of a working, procedurally-defined, microlens array 1910. The surface phase of the fablet program module transforms a slab of material into an array of aspherical small lenses 1920, by using displacement mapping. The volume phase of the fablet program module adds baffles 1930 between the small lenses 1920 and assigns the two materials used (clear for lenses 1920 and black for the baffles 1930). The baffles reduce the light leakage between neighboring lenses.

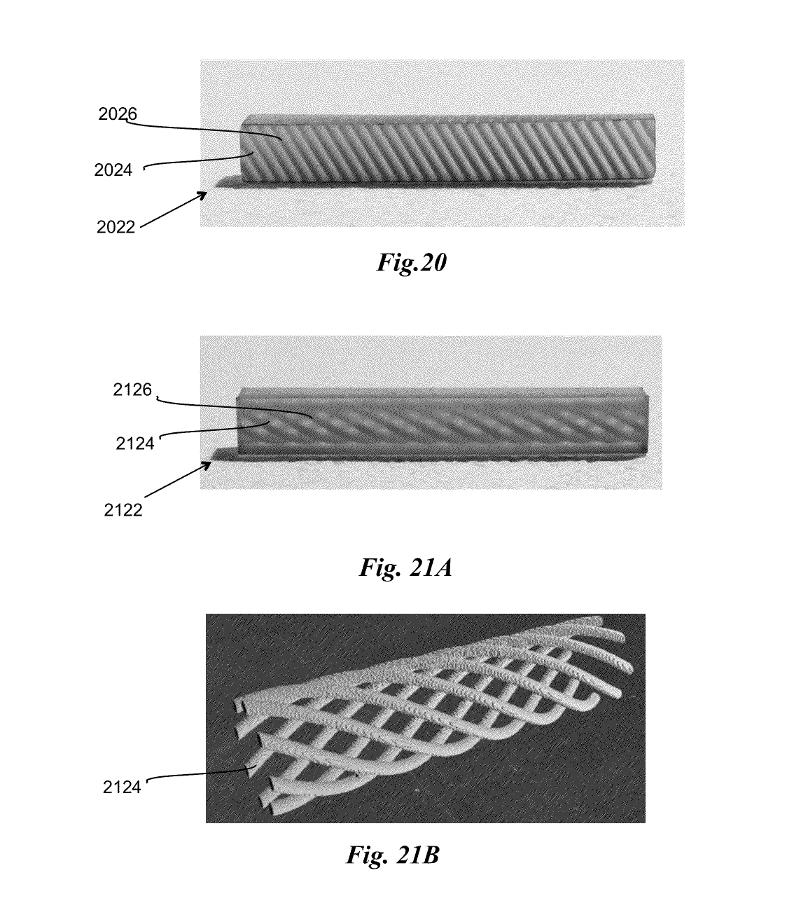

It is also possible to define procedurally-defined materials with anisotropic mechanical properties. FIG. 20 shows an object 2022, whose matrix 2026 is made of transparent and elastic material, but which appears relatively dark in the image. The volume phase of the fablet program module deposits transparent and elastic material throughout the object except in places where it emits slanted rods that are made of white and rigid material. If pressure is applied to the top left corner, the straight rods transform downward side pressure into transverse motion that causes elongation.

FIG. 21A shows an object 2122, whose matrix 2126 is also made of transparent and elastic material, but which appears relatively dark in the image. The volume phase of the fablet program module emits transparent and elastic material through the object except for places where it emits concentric helical rods that are made of white and rigid material. The shape of these helical rods is shown best in FIG. 21B, which is a schematic representation with the flexible matrix 2126 removed. These helical structures influence the mechanical behavior. They helical structures allow twisting motion of the object in a first direction around the long axis of the structure, but they allow very little twist in the opposite direction.

### Performance

The programmable pipeline architecture is a powerful way to describe and fabricate complex multi-material 3D prints with a wide range of mechanical and optical properties. The pipeline method and apparatus inventions described herein provide a solid and scalable foundation on which to build many multi-material fabrication techniques.

It is important to note that in many cases when multiple materials are discussed multiple is used to mean at least two different physical materials, such as a dark material and a light material. However, in addition, inventions hereof can treat a void, namely the printing or depositing of no material at a specific location, in an equivalent fashion to the printing or deposition of a specific first material that is different from a physical different (perhaps only) material. Thus, any method steps or apparatus features discussed herein as relating to multi-materials, should also be understood to refer to a method or apparatus that creates a product composed of a single physical material along also with voids that are to some extent surrounded at least in part by the single material. The voids are treated by the program modules and other aspects of methods and hardware inventions hereof as a second material. For instance, the geometry of the rhinoceros 1600C, with the channels (but assuming that it were only transparent material, with no black interior), would be composed of only a single physical material, namely the transparent polymer material, but the fablet program module deals with the fabrication as if there were two different materials, the presence of one of which happens to generate instructions to the printer to printing nothing in specific locations.

The foregoing has described use of the pipeline architecture and user programmable module aspects of inventions hereof primarily using as an example 3DP system, photopolymer phase-change and inkjet types of 3DP machines. However, inventions disclosed herein are useful in connection with virtually all types of 3DP machines. Inventions can be used with printers that: 1) can reliably print any of the available materials at any addressable location; and 2) can print in a given direction (like Z) or at least one sub-volume at a time, so that the streaming nature of the architecture can exercise its ability to work on small chunks at a time. The proceduralism and ability to place materials at each voxels requires the first criterion. The scalable architecture requires the second criterion.

The deposited substance can be a liquid or a slurry or solid particles. The particles can be metal, polymer, organic, inorganic, ceramic, living tissue. Gels can also be deposited, which are slightly different from liquids. For those aspects of inventions hereof that are relevant only to multi-material deposition, they are only relevant to machines that can dispense at least two different materials. Such techniques include but are not limited to those used with the following techniques: Fused Deposition Modeling (FDM), Electron Beam Freeform Fabrication (EBF); Direct Metal Laser Sintering (DMLS); Electron-Beam Melting (EBM); Selective Laser Melting (SLM); Selective Heat Sintering (SHS); Selective Laser Sintering (SLS); Plaster-based 3DP (PP); Laminated Object Manufacturing (LOM); Stereolithography (SLA); Photopolymer Phase-Change Inkjet Printing (PPIP), and Digital Light Processing (DLP).

Other aspects of inventions hereof are independent of whether one or multiple materials are printed. For instance, the use of fablet program modules, or other forms of procedural or user programmatic control over one or both of the surface stage or volume stage of fabrication of a 3DP object are considered to be inventions hereof, and they need not relate to a multiple material operation. The proceduralism and the ability to write fablet program modules is in itself novel and non-obvious and useful even for single material printing for two reasons. First, the ability to output void lets the designer carve out spaces, and displacements allow the designer to procedurally modify the surface of the object. Second, the scalable architecture described for how to process all of the data in a slab-wise fashion is independent of whether using only one or more materials.

This disclosure describes and discloses more than one invention. The inventions are set forth in the claims of this and related documents, not only as filed, but also as developed during prosecution of any patent application based on this disclosure. The inventors intend to claim all of the various inventions to the limits permitted by the prior art, as it is subsequently determined to be. No feature described herein is essential to each invention disclosed herein. Thus, the inventors intend that no features described herein, but not claimed in any particular claim of any patent based on this disclosure, should be incorporated into any such claim. Alternatively, in certain embodiments, it is contemplated that the independent features can be combined in order to enjoy the benefits and advantages of each feature.

For instance, the following different features are each potentially separate from each other, and can be used alone, or in combination with any single other one or any sub-combinations of the mentioned features: procedural control over the surface stage; procedural control over a volume stage; procedural control over a dithering stage; combining volume and surface phase procedural control in the same fablet program module; using proceduralism for more than one material; using proceduralism related to only a single printed material; establishing priorities of objects; conducting pre-calculation in advance; procedural displacement of surfaces.

Some assemblies of hardware, or groups of steps, are referred to herein as an invention. However, this is not an admission that any such assemblies or groups are necessarily patentably distinct inventions, particularly as contemplated by laws and regulations regarding the number of inventions that will be examined in one patent application, or unity of invention. It is intended to be a short way of saying an embodiment of an invention.

An abstract is submitted herewith. It is emphasized that this abstract is being provided to comply with the rule requiring an abstract that will allow examiners and other searchers to quickly ascertain the subject matter of the technical disclosure. It is submitted with the understanding that it will not be used to interpret or limit the scope or meaning of the claims, as promised by the Patent Office's rule.

The foregoing discussion should be understood as illustrative and should not be considered to be limiting in any sense. While the inventions have been particularly shown and described with references to preferred embodiments thereof, it will be understood by those skilled in the art that various changes in form and details may be made therein without departing from the spirit and scope of the inventions as defined by the claims.

The corresponding structures, materials, acts and equivalents of all means or step plus function elements in the claims below are intended to include any structure, material, or acts for performing the functions in combination with other claimed elements as specifically claimed.

### ASPECTS OF INVENTIONS

The following aspects of inventions hereof are intended to be described herein, and this section is to ensure that they are mentioned. They are styled as aspects, and although they appear similar to claims, they are not claims. However, at some point in the future, the applicants reserve the right to claim any and all of these aspects in this and any related applications.

A1. A method for generating a volume discretized representation of at least one object, usable in connection with fabricating, by a 3DP method, at least one object that corresponds to the representation, at a specified printer resolution of volume elements, to be printed by the 3DP method, the method comprising:
a. tessellating a boundary representation of the at least one object to produce a tessellated boundary representation comprising a set of micropolygons, the micropolygons having a size that matches the specified printer resolution;
b. evaluating, for the at least one object, a program module having a surface phase, which generates as an output a modified boundary representation, modified according to at least one procedural aspect of the surface phase; and
c. volume discretizing the modified boundary representation at the specified print resolution, to generate a volume discretized modified representation comprising volume elements.

A2. The method of aspect 1, the at least one procedural aspect of the surface phase being selected from the group consisting of:

a. applying a function to the tessellated boundary representation;

b. sampling an image texture;

c. a displacement; and

d. procedurally determining surface attributes.

A3. The method of aspect 2, further comprising evaluating, for the at least one object, a program module having a volume phase, which generates as an output a volume discretized representation, which is enriched according to at least one procedural aspect of the volume phase.

A4. The method of aspect 3, the at least one procedural aspect of the volume phase comprising the step of assigning at least one of a plurality of fabrication materials to each volume element to generate a volume discretized representation with material assignments.

A5. The method of aspect 3, the at least one procedural aspect of the volume phase comprising the step of assigning to each volume element, one of:

a. a fabrication material; and

b. a void.

A6. The method of aspect 4, the step of assigning at least one of a plurality of fabrication materials to each volume element comprising procedurally assigning at least two different materials in different degrees to generate a volume discretized representation graded material assignments.

A7. The method of aspect 4, wherein the step of assigning at least one of a plurality of fabrication materials to each volume element, comprises the step of assigning at least two fabrication materials to individual ones of at least some of the volume elements, thereby producing a blended material representation.

A8. The method of aspect 7, further comprising, based on the blended material representation, the step of generating a dithered representation of, in which each volume element is assigned at most a single material.

A9. The method of aspect 8, the step of generating a dithered representation comprising a three-dimensional dithering.

A10. The method of aspect 8, wherein the object is to be printed in a set of slices, the step of generating a dithered representation comprising, within each single slice, applying a Floyd-Stenberg-type dithering technique.

A11. The method of aspect 8, the step of generating a dithered representation comprising, evaluating a program module having a dither phase, which takes as an input a user provided, sized, local neighborhood of volume elements of the blended material representation, and generates as an output a dithered representation of volume elements, composed of volume elements in a related, dithered neighborhood, each volume element in the related, dithered neighborhood being assigned only a single fabrication material.

A12. The method of aspect 8, further comprising the step of using the dithered representation to generate a machine-specific representation, which is specifically tailored to be used as an input to a specific type of 3DP machine.

A13. The method of aspect 4, said at least one object comprising at least a first and a second object, the boundary representations of the first object and second objects being part of a fabrication graph, which establishes their relative positional location to each other, and also the relative positional locations to each other of the respective output representation of volume elements for each of the first and second objects, further comprising,
a. assigning to each object a unique priority value, from a lowest priority value to a highest priority value;
b. further wherein the step of, for each object assigning at least one of a plurality of fabrication materials to each volume element of the respective representation, comprises, for any volume element determining whether the volume element resides in the same location of the fabrication graph as a volume element of an other object having a higher priority value, and, if so, assigning to that volume element the fabrication material that is assigned to the object having a higher priority value.

A14. A method for fabricating by a 3D printing method at least one object, described in a fabrication graph, the 3D printing method having a build direction, the at least one objects being arranged along the build direction in the fabrication graph, the method comprising:
a. sorting the at least one objects in the build direction;
b. partitioning the at least one object into a plurality of slab portions arranged in order along the build direction from a first slab to a last slab;
c. for each slab, beginning with the first and ending with the last, conducting the steps of:
   i. identifying all objects of which a portion of the object is within the slab; and
   ii. for each object, conducting the steps of:
      A. tessellating the object;
      B. executing a surface fablet program module on the tessellated object;
      C. volume discretizing the tessellated object to produce a representation characterized by volume elements; and
      D. executing a volume fablet program module on the volume discretized object.

A15. The method of aspect 14, further comprising the step of executing a volume fablet program module on the volume discretized object, which generates as an output a blended material representation of the object.

A16. The method of aspect 15, further comprising the step of dithering the blended material representation thereby generating a multi-material dithered representation of the object in which each volume element is assigned only a single material.

A17. An apparatus for generating a volume discretized representation of at least one object, usable in connection with fabricating, by a 3DP method, at least one object that corresponds to the representation, at a specified printer resolution of volume elements, to be printed by the 3DP method, the apparatus comprising:
a. a tesselator configured to tessellate a boundary representation of the at least one object to produce a tessellated boundary representation comprising a set of micropolygons, the micropolygons having a size that matches the specified printer resolution;
b. a surface stage processor, configured to evaluate, a program module having a surface phase, which generates as an output a modified boundary representation, modified according to at least one procedural aspect of the surface phase; and
c. a volume discretizer, configured to discretize the modified boundary representation at the specified print resolution, to generate a volume discretized modified representation of volume elements.

A18. The apparatus of aspect 17, further comprising a processor configured to evaluate, for the at least one object, a program module having a volume phase, which generates as an output an enriched discretized representation of volume elements, which is enriched according to at least one procedural aspect of the volume phase.

A19. The apparatus of aspect 18, the at least one procedural aspect of the volume phase comprising assigning at least one of a plurality of fabrication materials to each volume element to generate a discretized representation of volume elements, enriched with material composition.

A20. The apparatus of aspect 18, the at least one procedural aspect of the volume phase comprising assigning at least two of a plurality of fabrication materials to each volume element to generate a discretized representation of volume elements, enriched with blended material composition.

A21. The apparatus of aspect 20, further comprising, a ditherer, which, based on the blended material composition, generates a dithered representation of volume elements, in which dithered representation, each volume element is assigned at most a single material.

A22. The apparatus of aspect 21, the ditherer comprising a procedural ditherer.

A23. The apparatus of aspect 21, the ditherer comprising a three dimensional ditherer.

A24. The apparatus of aspect 21, the object to be printed by the 3DP method in a set of slices, the ditherer comprising a Floyd-Steinberg-like ditherer, which takes into account material information from a single 3DP slice and also slices adjacent to the single slice.

A25. The apparatus of aspect 21, the object to be printed by the 3DP method in a set of slices, further comprising a 3D printer specific output processor, which generates, based on the dithered representation of volume elements, a representation of the volume elements in a form suitable for the 3DP machine to directly output material as a slice of volume elements.

A26. The apparatus of aspect 25, the 3DP printer specific output processor comprising a raster slice generator.

A27. A computer program product for generating a volume discretized representation of at least one object, usable in connection with fabricating, by a 3DP method, at least one object that corresponds to the representation, at a specified printer resolution of volume elements, to be printed by the 3DP method, the computer program product comprising computer executable code embodied in a non-transitory computer-readable medium that, when executing on one or more computing devices, performs the steps comprising:
a. tessellating a boundary representation of the at least one object to produce a tessellated boundary representation comprising a set of micropolygons, the micropolygons having a size that matches the specified printer resolution;
b. evaluating, for the at least one object, a program module having a surface phase, which generates as an output a modified boundary representation, modified according to at least one procedural aspect of the surface phase; and
c. volume discretizing the modified boundary representation at the specified print resolution, to generate a volume discretized modified representation comprising volume elements.

A28. The computer program product of aspect 27, the at least one procedural aspect of the surface phase being selected from the group consisting of:
a. applying a function to the tessellated boundary representation;
b. sampling an image texture;
c. a displacement; and
d. procedurally determining surface attributes.

A29. The computer program product of aspect 28, further comprising computer executable code that, when executing on one or more computing devices, performs the steps comprising evaluating, for the at least one object, a program module having a volume phase, which generates as an output a volume discretized representation, which is enriched according to at least one procedural aspect of the volume phase.

A30. The computer program product of aspect 29, the at least one procedural aspect of the volume phase comprising the step of assigning at least one of a plurality of fabrication materials to each volume element to generate a volume discretized representation with material assignments.

A31. The computer program product of aspect 29, the at least one procedural aspect of the volume phase comprising the step of assigning to each volume element, one of:
a. a fabrication material; and
b. a void.

A32. The computer program product of aspect 28, the step of assigning at least one of a plurality of fabrication materials to each volume element comprising procedurally assigning at least two different materials in different degrees to generate a volume discretized representation graded material assignments.

A33. The computer program product of aspect 28, wherein the step of assigning at least one of a plurality of fabrication materials to each volume element comprises the step of assigning at least two fabrication materials to individual ones of at least some of the volume elements, thereby producing a blended material representation.

A34. The computer program product of aspect 33, further comprising, computer executable code that, when executing on one or more computing devices, performs, based on the blended material representation, the step of generating a dithered representation of, in which each volume element is assigned at most a single material.

A35. The computer program product of aspect 34, the step of generating a dithered representation comprising a three-dimensional dithering.

A36. The computer program product of aspect 34, wherein the object is to be printed in a set of slices, the step of generating a dithered representation comprising, within each single slice, applying a Floyd-Stenberg-type dithering technique.

A37. The computer program product of aspect 34, the step of generating a dithered representation comprising, evaluating a program module having a dither phase, which takes as an input a user provided, sized, local neighborhood of volume elements of the blended material representation, and generates as an output a dithered representation of volume elements, composed of volume elements in a related, dithered neighborhood, each volume element in the related, dithered neighborhood being assigned only a single fabrication material.

A38. The computer program product of aspect 34, further comprising computer executable code that, when executing on one or more computing devices, performs the step of using the dithered representation to generate a machine-specific representation, which is specifically tailored to be used as an input to a specific type of 3DP machine.

A39. The computer program product of aspect 30, said at least one object comprising at least a first and a second object, the boundary representations of the first object and second objects being part of a fabrication graph, which establishes their relative positional location to each other, and also the relative positional locations to each other of the respective output representation of volume elements for each of the first and second objects, the computer program product further comprising computer executable code that, when executing on one or more computing devices, performs the steps:
a. assigning to each object a unique priority value, from a lowest priority value to a highest priority value;
b. further wherein the step of, for each object assigning at least one of a plurality of fabrication materials to each volume element of the respective representation, comprises, for any volume element determining whether the volume element resides in the same location of the fabrication graph as a volume element of an other object having a higher priority value, and, if so, assigning to that volume element the fabrication material that is assigned to the object having a higher priority value.

A40. A computer program product for fabricating by a 3D printing method at least one object, described in a fabrication graph, the 3D printing method having a build direction, the at least one objects being arranged along the build direction in the fabrication graph, the method comprising:
a. sorting the at least one objects in the build direction;
b. partitioning the at least one object into a plurality of slab portions arranged in order along the build direction from a first slab to a last slab;
c. for each slab, beginning with the first and ending with the last, conducting the steps of:
   i. identifying all objects of which a portion of the object is within the slab; and
   ii. for each object, conducting the steps of:
      A. tessellating the object;
      B. executing a surface fablet program module on the tessellated object;
      C. volume discretizing the tessellated object to produce a representation characterized by volume elements; and
      D. executing a volume fablet program module on the volume discretized object.

A41. The computer program product of aspect 40, further wherein the step of executing a volume fablet program module on the volume discretized object which generates as an output a blended material representation of the object.

A42. The computer program product of aspect 41, further comprising computer executable code that, when executing on one or more computing devices, performs the step of dithering the blended material representation thereby generating a multi-material dithered representation of the object in which each volume element is assigned only a single material.

A43. In a computer system, a method for generating a volume discretized representation of at least one object, usable in connection with fabricating, by a 3DP method, at least one object that corresponds to the representation, at a specified printer resolution of volume elements, to be printed by the 3DP method, the method comprising:
a. tessellating a boundary representation of the at least one object to produce a tessellated boundary representation comprising a set of micropolygons, the micropolygons having a size that matches the specified printer resolution;
b. evaluating, for the at least one object, a program module having a surface phase, which generates as an output a modified boundary representation, modified according to at least one procedural aspect of the surface phase; and
c. volume discretizing the modified boundary representation at the specified print resolution, to generate a volume discretized modified representation comprising volume elements.

A44. The method of aspect 43, the at least one procedural aspect of the surface phase being selected from the group consisting of:
a. applying a function to the tessellated boundary representation;
b. sampling an image texture;
c. a displacement; and
d. procedurally determining surface attributes.

A45. The method of aspect 44, further comprising evaluating, for the at least one object, a program module having a volume phase, which generates as an output a volume discretized representation, which is enriched according to at least one procedural aspect of the volume phase.

A46. The method of aspect 45, the at least one procedural aspect of the volume phase comprising the step of assigning at least one of a plurality of fabrication materials to each volume element to generate a volume discretized representation with material assignments.

A47. The method of aspect 45, the at least one procedural aspect of the volume phase comprising the step of assigning to each volume element, one of:

a. a fabrication material; and

b. a void.

A48. The method of aspect 46, the step of assigning at least one of a plurality of fabrication materials to each volume element comprising procedurally assigning at least two different materials in different degrees to generate a volume discretized representation graded material assignments.

A49. The method of aspect 46, wherein the step of assigning at least one of a plurality of fabrication materials to each volume element comprises the step of assigning at least two fabrication materials to individual ones of at least some of the volume elements, thereby producing a blended material representation.

A50. The method of aspect 49, further comprising, based on the blended material representation, the step of generating a dithered representation of, in which each volume element is assigned at most a single material.

A51. The method of aspect 50, the step of generating a dithered representation comprising a three-dimensional dithering.

A52. The method of aspect 50, wherein the object is to be printed in a set of slices, the step of generating a dithered representation comprising, within each single slice, applying a Floyd-Stenberg-type dithering technique.

A53. The method of aspect 50, the step of generating a dithered representation comprising, evaluating a program module having a dither phase, which takes as an input a user provided, sized, local neighborhood of volume elements of the blended material representation, and generates as an output a dithered representation of volume elements, composed of volume elements in a related, dithered neighborhood, each volume element in the related, dithered neighborhood being assigned only a single fabrication material.

A54. The method of aspect 50, further comprising the step of using the dithered representation to generate a machine-specific representation, which is specifically tailored to be used as an input to a specific type of 3DP machine.

A55. The method of aspect 46, said at least one object comprising at least a first and a second object, the boundary representations of the first object and second objects being part of a fabrication graph, which establishes their relative positional location to each other, and also the relative positional locations to each other of the respective output representation of volume elements for each of the first and second objects, further comprising,
a. assigning to each object a unique priority value, from a lowest priority value to a highest priority value;
b. further wherein the step of, for each object assigning at least one of a plurality of fabrication materials to each volume element of the respective representation, comprises, for any volume element determining whether the volume element resides in the same location of the fabrication graph as a volume element of an other object having a higher priority value, and, if so, assigning to that volume element the fabrication material that is assigned to the object having a higher priority value.

A56. In a computer system a method for fabricating by a 3D printing method at least one object, described in a fabrication graph, the 3D printing method having a build direction, the at least one objects being arranged along the build direction in the fabrication graph, the method comprising:
a. sorting the at least one objects in the build direction;
b. partitioning the at least one object into a plurality of slab portions arranged in order along the build direction from a first slab to a last slab;
c. for each slab, beginning with the first and ending with the last, conducting the steps of:
   i. identifying all objects of which a portion of the object is within the slab; and
   ii. for each object, conducting the steps of:
      A. tessellating the object;
      B. executing a surface fablet program module on the tessellated object;
      C. volume discretizing the tessellated object to produce a representation characterized by volume elements; and
      D. executing a volume fablet program module on the volume discretized object.

A57. the method of aspect 56, further wherein the step of executing a volume fablet program module on the volume discretized object which generates as an output a blended material representation of the object.

A58. The method of aspect 57, further comprising the step of dithering the blended material representation thereby generating a multi-material dithered representation of the object in which each volume element is assigned only a single material.

Having described the invention, what is claimed is:

1. A method for generating a volume discretized representation of at least one object, usable in connection with fabricating, by a 3DP method, at least one object that corresponds to the representation, at a specified printer resolution of volume elements, to be printed by the 3DP method, the method comprising:
a. tessellating a boundary representation of the at least one object to produce a tessellated boundary representation comprising a set of micropolygons, the micropolygons having a size that matches the specified printer resolution;
b. evaluating, for the at least one object, a program module having a surface phase, which generates as an output a modified boundary representation, modified according to at least one procedural aspect of the surface phase; and
c. volume discretizing the modified boundary representation at the specified print resolution, to generate a volume discretized modified representation comprising volume elements.

2. The method of claim 1, the at least one procedural aspect of the surface phase being selected from the group consisting of:
a. applying a function to the tessellated boundary representation;
b. sampling an image texture;
c. a displacement; and
d. procedurally determining surface attributes.

3. The method of claim 2, further comprising evaluating, for the at least one object, a program module having a volume phase, which generates as an output a volume discretized representation, which is enriched according to at least one procedural aspect of the volume phase.

4. The method of claim 3, the at least one procedural aspect of the volume phase comprising the step of assigning at least one of a plurality of fabrication materials to each volume element to generate a volume discretized representation with material assignments.

5. The method of claim 3, the at least one procedural aspect of the volume phase comprising the step of assigning to each volume element, one of:
a. a fabrication material; and
b. a void.

6. The method of claim 4, the step of assigning at least one of a plurality of fabrication materials to each volume element comprising procedurally assigning at least two different materials in different degrees to generate a volume discretized representation graded material assignments.

7. The method of claim 4, wherein the step of assigning at least one of a plurality of fabrication materials to each volume element, comprises the step of assigning at least two fabrication materials to individual ones of at least some of the volume elements, thereby producing a blended material representation.

8. The method of claim 7, further comprising, based on the blended material representation, the step of generating a dithered representation of, in which each volume element is assigned at most a single material.

9. The method of claim 8, the step of generating a dithered representation comprising a three-dimensional dithering.

10. The method of claim 8, wherein the object is to be printed in a set of slices, the step of generating a dithered representation comprising, within each single slice, applying a Floyd-Stenberg-type dithering technique.

11. The method of claim 8, the step of generating a dithered representation comprising, evaluating a program module having a dither phase, which takes as an input a user provided, sized, local neighborhood of volume elements of the blended material representation, and generates as an output a dithered representation of volume elements, composed of volume elements in a related, dithered neighborhood, each volume element in the related, dithered neighborhood being assigned only a single fabrication material.

12. The method of claim 8, further comprising the step of using the dithered representation to generate a machine-specific representation, which is specifically tailored to be used as an input to a specific type of 3DP machine.

13. The method of claim 4, said at least one object comprising at least a first and a second object, the boundary representations of the first object and second objects being part of a fabrication graph, which establishes their relative positional location to each other, and also the relative positional locations to each other of the respective output representation of volume elements for each of the first and second objects, further comprising,
a. assigning to each object a unique priority value, from a lowest priority value to a highest priority value;
b. further wherein the step of, for each object assigning at least one of a plurality of fabrication materials to each volume element of the respective representation, comprises, for any volume element determining whether the volume element resides in the same location of the fabrication graph as a volume element of an other object having a higher priority value, and, if so, assigning to that volume element the fabrication material that is assigned to the object having a higher priority value.

14. A method for fabricating by a 3D printing method at least one object, described in a fabrication graph, the 3D printing method having a build direction, the at least one objects being arranged along the build direction in the fabrication graph, the method comprising:
a. sorting the at least one objects in the build direction;
b. partitioning the at least one object into a plurality of slab portions arranged in order along the build direction from a first slab to a last slab;
c. for each slab, beginning with the first and ending with the last, conducting the steps of:
i. identifying all objects of which a portion of the object is within the slab; and
ii. for each object, conducting the steps of:
A. tessellating the object;
B. executing a surface fablet program module on the tessellated object;
C. volume discretizing the tessellated object to produce a representation characterized by volume elements; and
D. executing a volume fablet program module on the volume discretized object.

15. The method of claim 14, further comprising the step of executing a volume fablet program module on the volume discretized object, which generates as an output a blended material representation of the object.

16. The method of claim 15, further comprising the step of dithering the blended material representation thereby generating a multi-material dithered representation of the object in which each volume element is assigned only a single material.

17. An apparatus for generating a volume discretized representation of at least one object, usable in connection with fabricating, by a 3DP method, at least one object that corresponds to the representation, at a specified printer resolution of volume elements, to be printed by the 3DP method, the apparatus comprising:
a. a tesselator configured to tessellate a boundary representation of the at least one object to produce a tessellated boundary representation comprising a set of micropolygons, the micropolygons having a size that matches the specified printer resolution;
b. a surface stage processor, configured to evaluate, a program module having a surface phase, which generates as an output a modified boundary representation, modified according to at least one procedural aspect of the surface phase; and
c. a volume discretizer, configured to discretize the modified boundary representation at the specified print resolution, to generate a volume discretized modified representation of volume elements.

18. The apparatus of claim 17, further comprising a processor configured to evaluate, for the at least one object, a program module having a volume phase, which generates as an output an enriched discretized representation of volume elements, which is enriched according to at least one procedural aspect of the volume phase.

19. The apparatus of claim 18, the at least one procedural aspect of the volume phase comprising assigning at least one of a plurality of fabrication materials to each volume element to generate a discretized representation of volume elements, enriched with material composition.

20. The apparatus of claim 18, the at least one procedural aspect of the volume phase comprising assigning at least two of a plurality of fabrication materials to each volume element to generate a discretized representation of volume elements, enriched with blended material composition.

21. The apparatus of claim 20, further comprising, a ditherer, which, based on the blended material composition, generates a dithered representation of volume elements, in which dithered representation, each volume element is assigned at most a single material.

22. The apparatus of claim 21, the ditherer comprising a procedural ditherer.

23. The apparatus of claim 21, the ditherer comprising a three dimensional ditherer.

24. The apparatus of claim 21, the object to be printed by the 3DP method in a set of slices, the ditherer comprising a Floyd-Steinberg-like ditherer, which takes into account material information from a single 3DP slice and also slices adjacent to the single slice.

25. The apparatus of claim 21, the object to be printed by the 3DP method in a set of slices, further comprising a 3D printer specific output processor, which generates, based on the dithered representation of volume elements, a representation of the volume elements in a form suitable for the 3DP machine to directly output material as a slice of volume elements.

26. The apparatus of claim 25, the 3DP printer specific output processor comprising a raster slice generator.

27. A computer program product for generating a volume discretized representation of at least one object, usable in connection with fabricating, by a 3DP method, at least one object that corresponds to the representation, at a specified printer resolution of volume elements, to be printed by the 3DP method, the computer program product comprising computer executable code embodied in a non-transitory computer-readable medium that, when executing on one or more computing devices, performs the steps comprising:
a. tessellating a boundary representation of the at least one object to produce a tessellated boundary representation comprising a set of micropolygons, the micropolygons having a size that matches the specified printer resolution;
b. evaluating, for the at least one object, a program module having a surface phase, which generates as an output a modified boundary representation, modified according to at least one procedural aspect of the surface phase; and
c. volume discretizing the modified boundary representation at the specified print resolution, to generate a volume discretized modified representation comprising volume elements.

28. The computer program product of claim 27, the at least one procedural aspect of the surface phase being selected from the group consisting of:
a. applying a function to the tessellated boundary representation;
b. sampling an image texture;
c. a displacement; and
d. procedurally determining surface attributes.

29. The computer program product of claim 28, further comprising computer executable code that, when executing on one or more computing devices, performs the steps comprising evaluating, for the at least one object, a program module having a volume phase, which generates as an output a volume discretized representation, which is enriched according to at least one procedural aspect of the volume phase.

30. The computer program product of claim 29, the at least one procedural aspect of the volume phase comprising the step of assigning at least one of a plurality of fabrication materials to each volume element to generate a volume discretized representation with material assignments.

31. The computer program product of claim 28, the step of assigning at least one of a plurality of fabrication materials to each volume element comprising procedurally assigning at least two different materials in different degrees to generate a volume discretized representation graded material assignments.

32. A computer program product for fabricating by a 3D printing method at least one object, described in a fabrication graph, the 3D printing method having a build direction, the at least one objects being arranged along the build direction in the fabrication graph, the method comprising:
a. sorting the at least one objects in the build direction;
b. partitioning the at least one object into a plurality of slab portions arranged in order along the build direction from a first slab to a last slab;
c. for each slab, beginning with the first and ending with the last, conducting the steps of:
i. identifying all objects of which a portion of the object is within the slab; and
ii. for each object, conducting the steps of:
A. tessellating the object;
B. executing a surface fablet program module on the tessellated object;
C. volume discretizing the tessellated object to produce a representation characterized by volume elements; and
D. executing a volume fablet program module on the volume discretized object.

33. The computer program product of claim 32, further wherein the step of executing a volume fablet program module on the volume discretized object which generates as an output a blended material representation of the object.

34. The computer program product of claim 33, further comprising computer executable code that, when executing on one or more computing devices, performs the step of dithering the blended material representation thereby generating a multi-material dithered representation of the object in which each volume element is assigned only a single material.

35. In a computer system, a method for generating a volume discretized representation of at least one object, usable in connection with fabricating, by a 3DP method, at least one object that corresponds to the representation, at a specified printer resolution of volume elements, to be printed by the 3DP method, the method comprising:
a. tessellating a boundary representation of the at least one object to produce a tessellated boundary representation comprising a set of micropolygons, the micropolygons having a size that matches the specified printer resolution;
b. evaluating, for the at least one object, a program module having a surface phase, which generates as an output a modified boundary representation, modified according to at least one procedural aspect of the surface phase; and
c. volume discretizing the modified boundary representation at the specified print resolution, to generate a volume discretized modified representation comprising volume elements.

36. The method of claim 35, the at least one procedural aspect of the surface phase being selected from the group consisting of:
a. applying a function to the tessellated boundary representation;
b. sampling an image texture;
c. a displacement; and
d. procedurally determining surface attributes.

37. The method of claim 36, further comprising evaluating, for the at least one object, a program module having a volume phase, which generates as an output a volume discretized representation, which is enriched according to at least one procedural aspect of the volume phase.

38. In a computer system a method for fabricating by a 3D printing method at least one object, described in a fabrication graph, the 3D printing method having a build direction, the at least one objects being arranged along the build direction in the fabrication graph, the method comprising:
a. sorting the at least one objects in the build direction;
b. partitioning the at least one object into a plurality of slab portions arranged in order along the build direction from a first slab to a last slab;
c. for each slab, beginning with the first and ending with the last, conducting the steps of:
i. identifying all objects of which a portion of the object is within the slab; and
ii. for each object, conducting the steps of:
A. tessellating the object;
B. executing a surface fablet program module on the tessellated object;
C. volume discretizing the tessellated object to produce a representation characterized by volume elements; and
D. executing a volume fablet program module on the volume discretized object.
